(19) United States
(12) Patent Application Publication
(10) Pub. No.: US 2026/0274256 A1
(43) Pub. Date: Sep. 17, 2026

(54) VEHICLE CONTROL DEVICE

(71) Applicants: DENSO CORPORATION, Kariya-city (JP); AISIN CORPORATION, Kariya-city (JP); JTEKT CORPORATION, Kariya-city (JP); ADVICS CO., LTD., Kariya-city (JP)

(72) Inventor: Kota KAGA, Tokyo (JP)

(21) Appl. No.: 19/676,028

(22) Filed: May 13, 2026

Related U.S. Application Data
(63) Continuation of application No. PCT/JP2024/039179, filed on Nov. 4, 2024.

(30) Foreign Application Priority Data
Nov. 22, 2023 (JP) 2023-198401

(51) Int. Cl. B60W 30/14; B60W 10/06; B60W 10/08; B60W 10/18

(52) U.S. Cl. CPC B60W 30/143; B60W 10/06; B60W 10/08; B60W 10/18; B60W 2520/105; B60W 2552/05; B60W 2552/35; B60W 2720/10

(57) ABSTRACT

A vehicle control device that controls a driving force and a braking force of a vehicle passing over a change source which changes a vehicle speed by a wheel of the vehicle passing over or descending includes: an impulse calculation unit that calculates an impulse acting on the vehicle when the vehicle passes over the change source and outputs impulse information corresponding to the calculated impulse, a passage determination unit that determines passage over the change source based on the impulse information output by the impulse calculation unit, and a braking/driving calculation unit that calculates the driving force and the braking force when passing over the change source based on a determination result of the passage determination unit. The impulse calculation unit calculates, as the impulse information, a velocity impulse based on the vehicle speed when passing over the change source and a braking/driving impulse based on the driving force and the braking force when passing over the change source. The passage determination unit determines passage over the change source based on a difference between the velocity impulse and the braking/driving impulse calculated by the impulse calculation unit.

### CROSS-REFERENCE TO RELATED APPLICATIONS

The present application is a continuation application of International Application No. PCT/JP2024/039179 filed on Nov. 4, 2024, which claims priority to Japanese Patent Application No. 2023-198401 filed on Nov. 22, 2023. The contents of these applications are incorporated herein by reference in their entirety.

### BACKGROUND

### 1. Technical Field

The present disclosure relates to a vehicle control device.

### 2. Related Art

When a vehicle is started while passing over a step, a larger driving force is necessary compared to when a vehicle is started on a flat road surface. However, in order to prevent a vehicle speed from abruptly rising after having passed over the step due to the large driving force for passing over the step, the driving force after having passed over the step needs to be suppressed compared to before passing over the step. There has been known a control device, which suppresses the abrupt increase of a vehicle speed, when a vehicle starts while passing over a step (for example, see JP2007045230A). The conventional control device determines, based on a vehicle speed obtained when the vehicle starts, that a wheel has passed over the step and suppresses the driving force when it is determined that the wheel has passed over the step. The conventional control device calculates the vehicle speed from a moving average of a wheel angle acceleration, and determines that the wheel has passed over the step when the moving average of the wheel angle acceleration becomes greater than or equal to a set value.

### SUMMARY

According to an aspect of the present disclosure, a vehicle control device configured to control a driving force and a braking force of a vehicle passing over a change source which changes a vehicle speed by a wheel of the vehicle passing over or descending is provided. The vehicle control device comprises: an impulse calculation unit configured to calculate an impulse acting on the vehicle when the vehicle passes over the change source and outputs impulse information corresponding to the calculated impulse, a passage determination unit configured to determine passage over the change source, based on the impulse information output by the impulse calculation unit, and a braking/driving calculation unit configured to calculate the driving force and the braking force when passing over the change source, based on a determination result of the passage determination unit. The impulse calculation unit is configured to calculate, as the impulse information, a velocity impulse based on the vehicle speed when passing over the change source and a braking/driving impulse based on the driving force and the braking force when passing over the change source. The passage determination unit is configured to determine passage over the change source based on a difference between the velocity impulse and the braking/driving impulse calculated by the impulse calculation unit.

### BRIEF DESCRIPTION OF THE DRAWING

FIG. 1 is a schematic block diagram of a vehicle control device according to the present embodiment.

FIG. 2 is a diagram showing a state in which a vehicle passes over a step after colliding with the step.

FIG. 3 is a flowchart showing a control process executed by an automatic parking control device according to the present embodiment when a vehicle passes over a step.

FIG. 4 is a flowchart showing a control process executed by an automatic parking control device according to the present embodiment when a vehicle descends from a step.

FIG. 5 is a flowchart showing an automatic parking process executed by an automatic parking control device according to the present embodiment.

FIG. 6 is a diagram for explaining change of a velocity impulse when a vehicle has collided with a step.

FIG. 7 is a diagram for explaining change of a sum of a braking force and a driving force when a vehicle has collided with a step.

FIG. 8 is a diagram for explaining change of a disturbance impulse from before starting to when a wheel collides with a step.

FIG. 9 is a diagram for explaining a determination method from before starting to when a wheel having collided with a step has run on the step.

FIG. 10 is a diagram for explaining change of a disturbance impulse when a running wheel has collided with a step.

FIG. 11 is a diagram for explaining change of a disturbance impulse when a wheel has descended from a step.

### DETAILED DESCRIPTION OF THE PREFERRED EMBODIMENTS

When a step exists on a road surface on which a vehicle travels, the vehicle speed may lower when a wheel has collided with the step, and there is a concern that the vehicle speed may increase when having passed over the step, compared to immediately before passing over the step. Therefore, when a vehicle control device controls a driving force for the vehicle passing over the step and a driving force after having passed over the step, a method for controlling the driving forces includes a method of changing based on lowering of the vehicle speed, as in the control device according to JP2007045230A.

However, the vehicle speed of the vehicle lowers in response to a driver performing a brake operation during travelling. Therefore, it is difficult to determine, based on only the information of the vehicle speed, whether the lowering of the vehicle speed is caused by collision of the wheel with the step or the brake operation by the driver. Therefore, for example, if completion of passing over the step is determined based on the information of the vehicle speed, the completion of passing over the step may be erroneously determined. Further, if the vehicle control device controls the driving force based on the erroneous determination result that the wheel has passed over the step, there is a concern that the driving force may not be adequately controlled.

In this way, when the vehicle travels on the road surface on which a change source such as the step, which changes the vehicle speed exists, it is difficult to accurately determine passage over the change source by the method of determining passage over the change source based on the vehicle speed. As a result of detailed study of the inventor, it was found that the driving force when passing over the change source may not be adequately controlled when the vehicle control device determines passage over the change source based on the vehicle speed.

In view of the above-described point, the present disclosure aims to provide a vehicle control device capable of improving determination accuracy of passage over the change source.

According to an aspect of the present disclosure, a vehicle control device configured to control a driving force and a braking force of a vehicle passing over a change source which changes a vehicle speed by a wheel of the vehicle passing over or descending is provided. The vehicle control device comprises: an impulse calculation unit configured to calculate an impulse acting on the vehicle when the vehicle passes over the change source and outputs impulse information corresponding to the calculated impulse, a passage determination unit configured to determine passage over the change source, based on the impulse information output by the impulse calculation unit, and a braking/driving calculation unit configured to calculate the driving force and the braking force when passing over the change source, based on a determination result of the passage determination unit. The impulse calculation unit is configured to calculate, as the impulse information, a velocity impulse based on the vehicle speed when passing over the change source and a braking/driving impulse based on the driving force and the braking force when passing over the change source. The passage determination unit is configured to determine passage over the change source based on a difference between the velocity impulse and the braking/driving impulse calculated by the impulse calculation unit.

According to intensive study by the inventors, it was found that when the vehicle speed changes when passing over the change source, a difference occurs between the velocity impulse and the braking/driving impulse. Therefore, passage over the change source is accurately determined by the passage determination unit based on the difference between the velocity impulse and the braking/driving impulse, compared to when passage over the change source is determined based on a change of the vehicle speed.

Note that a bracketed reference sign attached to each constituent or the like denotes an example of the correspondence relation between the constituent or the like and a specific constituent or the like according to the later-described embodiment.

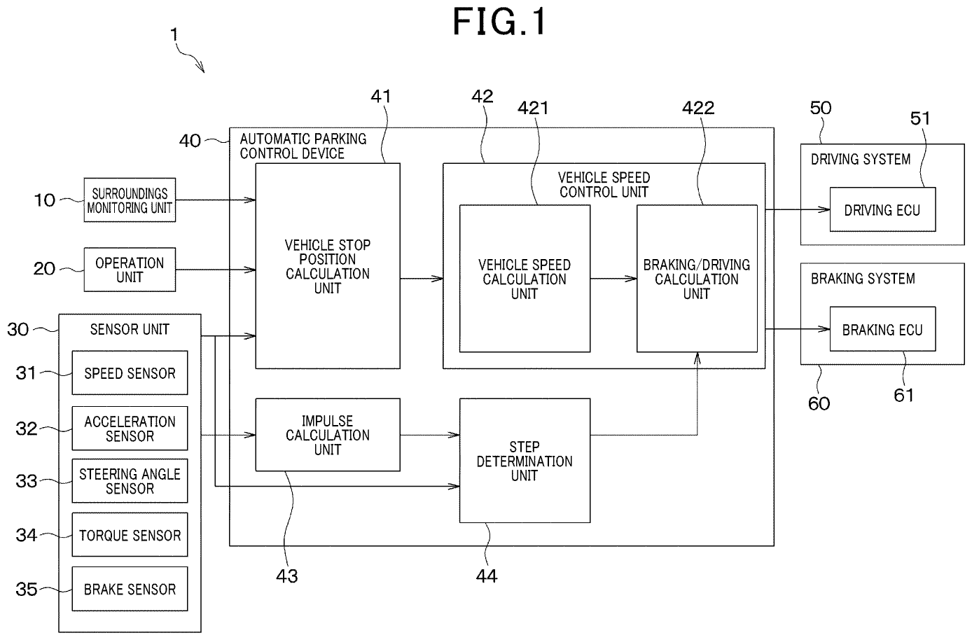

An embodiment of the present disclosure will be described based on FIG. 1 to FIG. 11. In the present disclosure, an example in which a vehicle control device 1 is applied to an electric vehicle having an automatic parking system will be described. The automatic parking system is a control system for automatically parking a subject vehicle in a parking space. The automatic parking system executes an automatic parking process and controls actions of various control target devices mounted on the subject vehicle so that the subject vehicle is run and parked in the parking space. The vehicle control device 1 of the present disclosure is configured integrally with the automatic parking system and can execute the automatic parking process executed by the automatic parking system.

As shown in FIG. 1, the vehicle control device 1 includes a surroundings monitoring unit 10, an operation unit 20, a sensor unit 30, an automatic parking control device 40, a driving system 50, and a braking system 60. The surroundings monitoring unit 10, the operation unit 20, the sensor unit 30, the automatic parking control device 40, the driving system 50, and the braking system 60 are used for the vehicle control device 1 executing the automatic parking process.

The surroundings monitoring unit 10 is an autonomous sensor that monitors a surrounding environment of the subject vehicle and detects a moving dynamic target such as a pedestrian and another vehicle and a resting static target such as a structure on a road. The surroundings monitoring unit 10 is configured by including, for example, a camera that takes a surroundings image of the subject vehicle and a sonar that outputs ultrasonic waves as probe waves and also acquires reflected waves thereof to detect an object existing in the surroundings of the subject vehicle. Further, the surroundings monitoring unit 10 may include a millimeter-wave radar that outputs millimeter waves as probe waves and light detection and ranging (LIDAR) that outputs laser beams as probe waves. The surroundings monitoring unit 10 is electrically connected to the automatic parking control device 40 and outputs a signal containing the detected information as sensing information to the automatic parking control device 40 every predetermined sampling period.

The operation unit 20 is a user interface that allows various instructions to be given to the vehicle control device 1 by an operation of an operator such as a driver. The operation unit 20 is configured by including, for example, an automatic parking start switch for the operator inputting a start signal of automatic parking. The automatic parking start switch is disposed, for example, around a center of an instrument panel. Note that the automatic parking start switch may be configured so as to be displayed on a touch-panel display. The operation unit 20 is electrically connected to the automatic parking control device 40 and transmits various signals input through the operation unit 20 to the automatic parking control device 40.

The sensor unit 30 is a sensor that detects various pieces of information regarding motion of the subject vehicle. The sensor unit 30 is configured by including, for example, as shown in FIG. 1, a speed sensor 31 that detects a vehicle speed of the subject vehicle, an acceleration sensor 32 that detects an acceleration of the subject vehicle, and a steering angle sensor 33 that detects a steering angle of a steering wheel. Further, the sensor unit 30 is configured by including a torque sensor 34 that detects output torque of the driving system 50 which outputs a driving force for running the subject vehicle as the electric vehicle, a brake sensor 35 that detects a braking force that brakes the subject vehicle, and the like. Note that although not shown, the sensor unit 30 may be configured by including a yaw rate sensor and the like. The sensor unit 30 is electrically connected to the automatic parking control device 40 and transmits various pieces of information detected by the sensor unit 30 to the automatic parking control device 40.

The speed sensor 31 is a sensor that detects the speed of the subject vehicle. The speed sensor 31 of the present embodiment is configured by a wheel speed sensor that detects a revolution of a wheel of the subject vehicle. The speed sensor 31 is provided near each of four wheels of the subject vehicle and outputs, as wheel speed pulses, detection signals of the quantity depending on a revolution angle of each of the four wheels. The speed sensor 31 outputs, every time the wheel revolves once, a pulse signal the previously set designed number of times (for example, 96 times) depending on the revolution angle of the wheel. In the present embodiment, the speed sensor 31 functions as a speed detection unit that outputs information corresponding to the detected vehicle speed.

The acceleration sensor 32 is a sensor that detects the acceleration of the subject vehicle based on an inertia force associated with acceleration of the subject vehicle. The acceleration sensor 32 is, for example, fixed to the subject vehicle and detects the accelerations in respective directions along three axes defined for the subject vehicle, specifically, in a front and rear direction, a left and right direction, and an upper and lower direction of the subject vehicle.

The steering angle sensor 33 is a sensor that detects an orientation and an operation amount of the steering wheel. The steering angle sensor 33 outputs the detection signal depending on the steering operation when the driver performs a steering operation, and outputs the detection signal depending on the steering angle of the steering wheel set by the automatic parking process when the automatic parking system executes the automatic parking process.

The torque sensor 34 is a sensor that detects the driving force of the subject vehicle by detecting the output torque of an unshown motor for running of the driving system 50. When the driver performs an operation of pressing an accelerator pedal, the torque sensor 34 outputs the detection signal depending on the output torque of the motor for running which acts depending on the pressing amount of the accelerator pedal. When the automatic parking system executes the automatic parking process, the torque sensor 34 outputs the detection signal depending on the output torque of the motor for running of the driving system 50 controlled by the automatic parking process.

The brake sensor 35 is a sensor that detects the braking force that occurs in the braking system 60 when the subject vehicle is decelerated or stopped. When the driver performs the operation of pressing a brake pedal, the brake sensor 35 outputs the detection signal depending on the braking force which occurs in the braking system 60 depending on the pressing amount of the brake petal. When the automatic parking system executes the automatic parking process, the brake sensor 35 outputs the detection signal depending on the braking force which occurs in the braking system 60 controlled by the automatic parking process.

The driving system 50 contains a later-described driving ECU 51. The driving system 50 includes, for example, the unshown motor for running that functions as a power source of the subject vehicle and an inverter that supplies power to the motor for running. The driving system 50 controls power supplied to the inverter to adjust a revolution force of the motor for running transmitted to the wheel, thereby controlling the output driving force.

The braking system 60 contains a later-described braking ECU 61. The braking system 60 includes, for example, an unshown brake rotor, brake pad, wheel cylinder, and the like. The braking system 60 adjusts a brake fluid pressure supplied to the wheel cylinder to control a friction force generated by pressing the brake pad against the brake rotor, thereby controlling the output braking force. The braking system 60 controls the respective braking forces generated in the four wheels.

The automatic parking control device 40 is a control device that executes the automatic parking process to control actions of various control target devices in response to the start signal of automatic parking being input. The automatic parking control device 40 is configured by a micro-computer containing a CPU, a ROM, a RAM, and the like and peripheral circuits thereof. Then, the automatic parking control device 40 performs various calculations and processes based on control programs stored in the ROM and controls actions of various control target devices connected to an output side thereof. Note that the ROM and the RAM of the automatic parking control device 40 are configured by non-transitory tangible storage media.

The automatic parking control device 40 includes a vehicle stop position calculation unit 41, a vehicle speed control unit 42, an impulse calculation unit 43, and a step determination unit 44. In response to the start signal of automatic parking being input, the automatic parking control device 40 executes the control programs stored in the ROM to function as the vehicle stop position calculation unit 41, the vehicle speed control unit 42, the impulse calculation unit 43, and the step determination unit 44. Alternatively, the automatic parking control device 40 may include a plurality of circuit modules corresponding to the vehicle stop position calculation unit 41, the vehicle speed control unit 42, the impulse calculation unit 43, and the step determination unit 44.

The vehicle stop position calculation unit 41 recognizes the surroundings environment of the subject vehicle based on the sensing information input from the surroundings monitoring unit 10, determines a target vehicle stop position as a target position in which the subject vehicle is to be parked, and generates a target running route to the target vehicle stop position. The vehicle stop position calculation unit 41 determines the target vehicle stop position and the target running route, based on, for example, the detection signal containing imaging data imaged by the camera of the surroundings monitoring unit 10 and information regarding objects detected by the sonar, the millimeter-wave radar, and the LIDAR.

The vehicle speed control unit 42 calculates a set value of each of the control target devices to be activated in order to park the subject vehicle in the target vehicle stop position. The vehicle speed control unit 42 includes a vehicle speed calculation unit 421 that calculates a set value of the vehicle speed when running the subject vehicle from a current position to the target vehicle stop position and a braking/driving calculation unit 422 that calculates the driving force and the braking force when running the subject vehicle from the current position to the target vehicle stop position.

The vehicle speed calculation unit 421 calculates a target speed that is a target vehicle speed in the target running route when moving the subject vehicle from the current position to the target vehicle stop position along the target running route determined by the vehicle stop position calculation unit 41. The vehicle speed calculation unit 421 transmits information of the determined target speed to the braking/driving calculation unit 422.

The braking/driving calculation unit 422 calculates the driving force and the braking force necessary for running the subject vehicle at the target speed calculated by the vehicle speed calculation unit 421 and calculates the set value for each of the control target devices necessary for acquiring the calculated driving force and braking force.

For example, the braking/driving calculation unit 422 calculates, as the target number of revolutions of the motor for running, the driving force of the motor for running necessary for running the subject vehicle at the target speed from the current position to the target vehicle stop position along the target running route. Further, for example, the braking/driving calculation unit 422 calculates, as the braking force, a target fluid pressure of brake fluid supplied to the wheel cylinder provided to each wheel when running the subject vehicle at the target speed from the current position to the target vehicle stop position along the target running route.

The braking/driving calculation unit 422 transmits information of the calculated driving force to the driving ECU 51 of the driving system 50 and transmits information of the calculated braking force to the braking ECU 61 of the braking system 60.

The driving ECU 51 controls power supplied to the inverter such that the number of revolutions of the motor for running becomes the target number of revolutions set by the braking/driving calculation unit 422. The driving ECU 51 controls the driving force output by the driving system 50 by controlling power supplied to the inverter such that the number of revolutions of the motor for running approaches the target number of revolutions.

The braking ECU 61 controls an action of an unshown actuator that adjusts the brake fluid pressure such that the brake fluid pressure to the wheel cylinder becomes the target fluid pressure set by the braking/driving calculation unit 422. The braking ECU 61 controls the braking force output by the braking system 60 by controlling the actuator such that the brake fluid pressure approaches the target fluid pressure.

Note that although not shown, the vehicle control device 1 of the present embodiment includes a steering system and calculates a target steering angle of the steering wheel when running the subject vehicle from the current position to the target vehicle stop position along the target running route in response to the start signal of automatic parking being input to the automatic parking control device 40. Then, an action of a steering motor that revolves the steering wheel is controlled such that the steering angle of the steering wheel becomes the target steering angle by the steering system.

In response to the start signal of automatic parking being input, the automatic parking control device 40 transmits various pieces of information necessary for parking the subject vehicle in the target vehicle stop position to each of the driving system 50, the braking system 60, and the steering system. In response to receiving various pieces of information from the automatic parking control device 40, the driving ECU 51 of the driving system 50 controls an action of the motor for running such that the output driving force approaches the target driving force calculated by the braking/driving calculation unit 422. In response to receiving various pieces of information from the automatic parking control device 40, the braking ECU 61 of the braking system 60 controls the actuator such that the output braking force approaches the target braking force calculated by the braking/driving calculation unit 422.

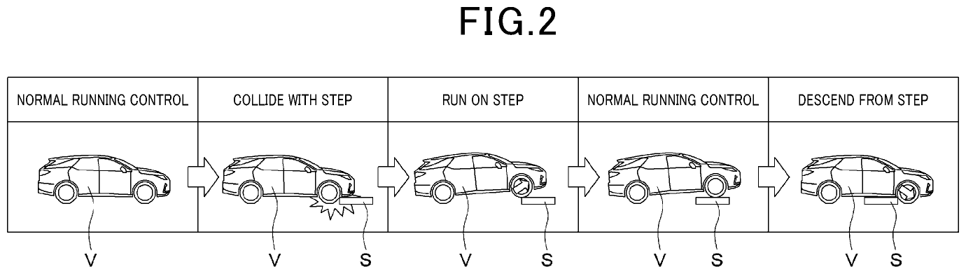

By the way, as shown in FIG. 2, a step S sometimes exists on a running road on which a vehicle V runs. The step S has a predetermined height, becomes an obstruction of the running of the vehicle V, and lowers a speed of the vehicle V when a wheel of the running vehicle V has collided with the step S. Further, when the stationary vehicle V starts from a state in which the wheel is in contact with the step S, the step S obstructs start of the vehicle V thereby to lower the acceleration and the speed of the vehicle V compared to when the step S does not exist.

Further, when the vehicle, which is running on the running road having a flat road surface at a constant speed or which has begun running from a state of stationary, descends from the step S, the step S raises the speed of the vehicle V. A reason why the speed of the vehicle V rises when the vehicle V descends from the step S is that the vehicle Vis subjected to gravity when descending from the step S, and the lower side in the vertical direction, i.e., in the weight direction, is subjected to a load attributable to the gravity, so that potential energy is converted into kinetic energy. In this manner, the step S becomes a change source that changes the speed of the vehicle V by the wheel of the vehicle V passing over the step S or descending from the step S.

When the running vehicle V is run while passing over the step S and when the stationary vehicle V is started while passing over the step S, a larger driving force is necessary compared to when run on the flat road surface on which the step S does not exist or when started on the flat road surface on which the step S does not exist. Therefore, in calculating the driving force necessary for running the subject vehicle at the target speed, the braking/driving calculation unit 422 increases a set value of the driving force for the wheel passing over the step S compared to when the step S does not exist. Further, in calculating the braking force necessary for running the subject vehicle at the target speed, the braking/driving calculation unit 422 decreases a set value of the braking force when the vehicle V passes over the step S compared to when the step S does not exist.

However, when the driving force is increased, and the braking force is decreased for passing over the step S, the vehicle V may abruptly accelerate immediately after the wheel has run on the step S. That is, the driving force increased for passing over the step S may cause the vehicle V to abruptly accelerate. Therefore, for preventing the vehicle speed from abruptly rising, it is required to lower the driving force immediately after the wheel has run on the step S compared to the set value set for passing over the step S. Further, it is required to raise the braking force immediately after the wheel has run on the step S compared to the set value set for passing over the step S.

Therefore, the braking/driving calculation unit 422 is required to decrease the set value of the driving force immediately after the wheel has run on the step S compared to before the wheel runs on the step S and to increase the set value of the braking force immediately after the wheel has run on the step S compared to before the wheel runs on the step S.

Further, since potential energy is converted into kinetic energy by the gravity when the vehicle V descends from the step S, and the vehicle speed rises, the vehicle speed may abruptly rise after the wheel descended from the step S and passed over the step S. Therefore, for preventing the vehicle speed from abruptly rising, it is required to lower the driving force immediately after the wheel has descended from the step S compared to the set value set before descending from the step S. Further, it is required to raise the braking force immediately after the wheel has descended from the step S compared to the set value set before descending from the step S.

Therefore, the braking/driving calculation unit 422 is required to decrease the set value of the driving force immediately after the wheel has descended from the step S compared to before the wheel descends from the step S or to increase the set value of the braking force immediately after the wheel descends from the step S compared to before the wheel descends from the step S.

In this manner, when the speed of the vehicle V may steeply change by passing over the change source that changes the speed of the vehicle V, the braking/driving calculation unit 422 needs to appropriately adjust the driving force and the braking force after having passed over the step S compared to before passage over the change source. Then, in order to appropriately adjust the driving force and the braking force after having passed over the step S, the vehicle control device 1 needs to accurately determine that the vehicle V has passed over the change source.

Therefore, the vehicle control device 1 of the present embodiment accurately determines passage over the step S when passing over the step S which becomes the change source that changes the speed of the vehicle V, and appropriately controls the driving force and the braking force of the vehicle V. The vehicle control device 1 of the present embodiment includes, as shown in FIG. 1, the step determination unit 44 that determines the passage over the step S and the impulse calculation unit 43 that calculates information necessary for the step determination unit 44 determining the passage over the step S.

The step determination unit 44 detects that the wheel has collided with the step S when the wheel of the running vehicle V has collided with the step S and also detects that the wheel is in a state of being in contact with the step S when the stationary vehicle starts from a state in which the wheel is in contact with the step S. Further, the step determination unit 44 detects that the wheel has run on the step S when the wheel has run on the step S after the running vehicle V collided with the step S and when the wheel has run on the step S after the stationary vehicle V with the wheel being in contact with the step S started. Further, the step determination unit 44 detects that the wheel has descended from the step S when the wheel of the running vehicle V has descended from the step S. The step determination unit 44 determines the passage over the step S based in information acquired from the impulse calculation unit 43. The step determination unit 44 of the present embodiment functions as a passage determination unit that determines the passage over the step S which is the change source. Details of the determination method will be described later.

As information necessary for the step determination unit 44 detecting these detections, the impulse calculation unit 43 calculates an impulse acting on the vehicle V by the passage over the step S. The impulse calculation unit 43 calculates the impulse acting on the vehicle V by the passage over the step S based on various pieces of information transmitted from the sensor unit 30 and transmits impulse information corresponding to the calculated impulse to the step determination unit 44. Details of the calculation method of the impulse will be described later.

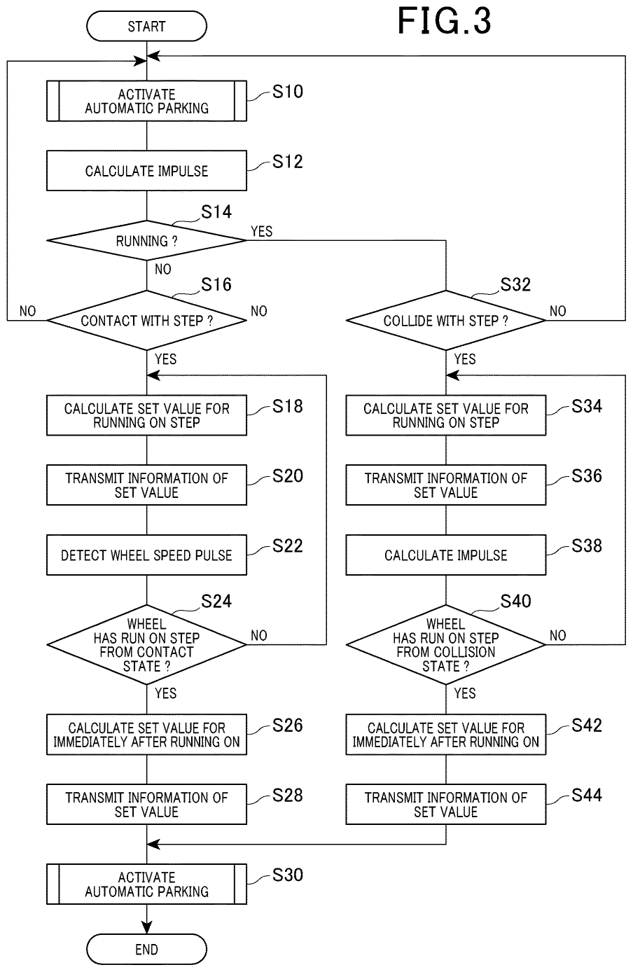

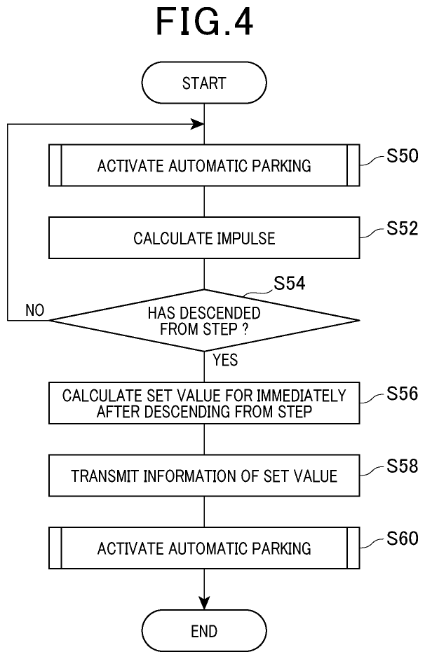

Subsequently, an example of an action process in which the automatic parking control device 40 of the vehicle control device 1 of the present embodiment executes the automatic parking process will be described with reference to flowcharts shown in FIG. 3 and FIG. 4 described later. Control processes shown in FIG. 3 and FIG. 4 are, for example, executed periodically in response to the operator operating the automatic parking start switch to input the start signal of automatic parking to the vehicle control device 1, and end when the vehicle V is parked to complete the automatic parking process. Further, the control processes shown in FIG. 3 and FIG. 4 contain the control process executed when the vehicle V passes over the step S.

Specifically, the control process shown in FIG. 3 contains the control process executed after the vehicle V has run on the step S from a state before running on the step S. Further, the control process shown in FIG. 4 contains the control process executed after the vehicle V has descended from the step S from a state of having run on the step S. The control processes shown in FIG. 3 and FIG. 4 may be executed at the same time, or the control process shown in FIG. 4 may be executed after the control process shown in FIG. 3 has been executed. In the present embodiment, an example in which the control processes shown in FIG. 3 and FIG. 4 are executed at the same time will be described.

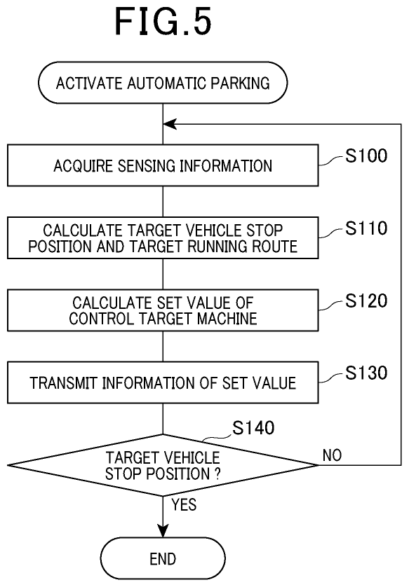

First, the control process containing the control process executed after the vehicle V has run on the step S from a state before running on the step S will be described with reference to FIG. 3 and FIG. 5.

In response to the start signal of automatic parking being input, the automatic parking control device 40 first starts the automatic parking action in step S10. Specifically, as shown in FIG. 5, the automatic parking control device 40 first acquires the sensing information from the surroundings monitoring unit 10 in step S100. For example, the automatic parking control device 40 acquires imaging data from the camera and also acquires information of the objects existing in respective detection ranges of the sonar, the millimeter-wave radar, and the LIDAR from the sonar, the millimeter-wave radar, and the LIDAR, as the sensing information.

Subsequently, in step S110, the automatic parking control device 40 recognizes the surroundings environment of the subject vehicle based on various pieces of information acquired by the vehicle stop position calculation unit 41 from the surroundings monitoring unit 10 and determines the target vehicle stop position and the target running route.

Subsequently, in step S120, the vehicle speed control unit 42 calculates the respective set values of the control target devices to be activated for stopping the subject vehicle in the target vehicle stop position. Specifically, the vehicle speed calculation unit 421 calculates the target speed for moving the vehicle V from the current position to the target vehicle stop position along the target running route determined by the vehicle stop position calculation unit 41. Then, the braking/driving calculation unit 422 calculates the driving force necessary for running the subject vehicle at the target speed calculated by the vehicle speed calculation unit 421 along the target running route determined by the vehicle stop position calculation unit 41. Further, the braking/driving calculation unit 422 calculates the braking force necessary for running the subject vehicle at the target speed calculated by the vehicle speed calculation unit 421 along the target running route determined by the vehicle stop position calculation unit 41. In addition, the braking/driving calculation unit 422 calculates the target steering angle of the steering wheel necessary for running the subject vehicle along the target running route.

Subsequently, in step S130, the automatic parking control device 40 transmits information of the various set values calculated by the braking/driving calculation unit 422 to the driving system 50, the braking system 60, and the steering system. Specifically, the braking/driving calculation unit 422 transmits information of the driving force to the driving ECU 51 of the driving system 50, transmits information of the calculated braking force to the braking ECU 61 of the braking system 60, and transmits information of the calculated steering angle to the steering system.

Accordingly, respective actions of the motor for running that outputs the driving force, the actuator that adjusts the brake fluid pressure which outputs the braking force, and the steering motor that controls the steering angle are started, and the automatic parking is performed.

Subsequently, in step S140, the automatic parking control device 40 determines whether the current position of the vehicle Vis the target vehicle stop position. In response to determining that the current position of the vehicle V is the target vehicle stop position, the automatic parking control device 40 determines that the vehicle V has run to the target vehicle stop position and ends the automatic parking process. The automatic parking control device 40 repeatedly executes the process of step S100 to step S140 until it is determined in step S140 that the current position of the vehicle Vis the target vehicle stop position. That is, the automatic parking action is continued until it is determined in step S140 that the subject vehicle has run to the target vehicle stop position.

By the way, when the step S shown in FIG. 2 exists on the running road on which the vehicle V runs, the wheel of the vehicle V may be brought into contact with or collide with the step S. For example, when the step S exists on the road surface on which the vehicle V runs, the wheel of the vehicle V may collide with the step S. Further, when the vehicle V stops in a state in which the wheel of the vehicle V has collided with the step S, the wheel becomes in a state of having collided with the step S before starting, that is, in a state in which the wheel of the stationary vehicle Vis in contact with the step S.

Then, as described above, when the vehicle V running on the road surface collides with the step S and passes over the step S, the driving force for passing over the step S may be required to be larger compared to before colliding with the step S. Further, when the vehicle V is started while passing over the step S in a state in which the wheel of the stationary vehicle Vis in contact with the step S, the driving force for passing over the step S is required to be larger compared to when the step S does not exist. Then, as described above, in order to prevent the vehicle speed after having passed over the step S from abruptly rising, the driving force after having passed over the step S needs to be lower than the driving force set to be large for passing over the step S.

Therefore, in the control process shown in FIG. 3, the automatic parking control device 40 of the present embodiment executes the process of step S12 and later during the automatic parking action and determines, before the vehicle V runs on the step S, whether the wheel is in contact with or collides with the step S. Then, when the wheel is in contact with or collides with the step S, the automatic parking control device 40 sets the set value of the driving force to a magnitude that allows for passing over the step S and also lowers the driving force after having passed over the step S. The control process of step S12 and later will be described.

In the automatic parking control device 40, the impulse calculation unit 43 calculates the impulse acting on the vehicle V in step S12 during the automatic parking action. Then, in the automatic parking control device 40, the step determination unit 44 determines, in step S16 and step S32, whether the wheel of the vehicle Vis in contact with or collides with the step S based on the impulse calculated by the impulse calculation unit 43.

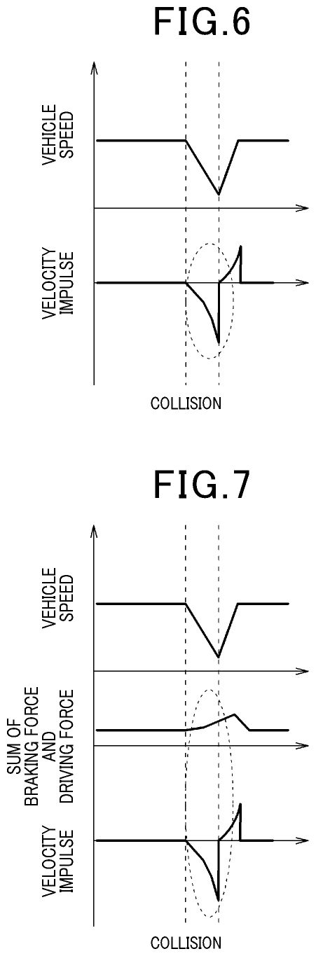

When the step S exists on the road surface, the impulse calculation unit 43 calculates the impulse acting on the vehicle V when the vehicle V passes over the step S, based on various pieces of information acquired from the sensor unit 30. Here, the impulse acting on the vehicle V will be described with reference to FIG. 6 and FIG. 7.

The impulse acting on the vehicle V is calculated based on the speed when the vehicle V runs, that is, the vehicle speed. Hereinafter, the impulse calculated based on the vehicle speed is referred to as a velocity impulse. The velocity impulse acting on the vehicle V when the vehicle V runs on the road surface for a predetermined time is calculated by integrating a value calculated by multiplying the weight of the vehicle V by the acceleration of the vehicle V. For example, when the weight of the vehicle Vis vehicle weight M, and the acceleration of the vehicle Vis vehicle acceleration a, the velocity impulse is calculated based on equation 1 shown below. The impulse calculation unit 43 calculates, as the impulse information, the velocity impulse based on equation 1.

Velocity impulse=∫(vehicle weight M×vehicle acceleration a) (1)

Then, as shown in FIG. 6, the velocity impulse when the vehicle speed changes in such a manner as continuing lowering for a certain time and thereafter continuing increasing for a certain time is less than 0 while the vehicle speed is lowering, and is more than 0 while the vehicle speed is increasing. Note that vehicle acceleration a is 0 in a state in which the vehicle speed is constant without acceleration and deceleration or in a state in which the vehicle Vis stationary. In this case, the velocity impulse is 0.

The impulse calculation unit 43 acquires, from the sensor unit 30, information of vehicle acceleration a for calculating the velocity impulse. As vehicle acceleration a for calculating the velocity impulse, information of the acceleration detected by the acceleration sensor 32 of the sensor unit 30 may be used, or a differential value calculated by differentiating the speed detected by the speed sensor 31 may be used. In the present embodiment, the impulse calculation unit 43 uses the differential value of the speed detected by the speed sensor 31 as vehicle acceleration a. As vehicle weight M, a previously set design value may be used.

As shown in FIG. 6, the velocity impulse lowers in magnitude with lowering of the vehicle speed. Therefore, when the wheel of the running vehicle V running on the road surface collides with the step S so that the vehicle speed lowers, the velocity impulse decreases compared to before colliding with the step S.

Then, when the vehicle V has collided with the step S, the set value of the driving force set by the braking/driving calculation unit 422 for passing over the step S may be required to be greater than the set value set in step S120 of the previous control period. Further, in order to prevent the vehicle speed from abruptly rising immediately after the wheel has run on the step S by the increased driving force, the set value of the driving force set by the braking/driving calculation unit 422 may be required to be lower than the set value increased for passing over the step S.

In this manner, when the running vehicle V has collided with the step S, the braking/driving calculation unit 422 may need to change the set value of the driving force. Therefore, it is required to accurately detect that the wheel has collided with the step S. Further, in order for the braking/driving calculation unit 422 to decrease the set value of the driving force immediately after the wheel has run on the step S, it is required to accurately detect that the wheel has run on the step S after the wheel collided with the step S.

Here, the inventors studied accurately detecting collision with the step S by detecting change of the velocity impulse which lowers with the lowering of the vehicle speed caused by the wheel colliding with the step S.

However, the vehicle speed of the vehicle V may also lower due to the driver performing the brake operation during running. Then, when the vehicle speed lowers due to the driver performing the brake operation, the velocity impulse also lowers with the lowering of the vehicle speed. Therefore, it is difficult to determine, by only detecting the lowering of the velocity impulse, whether the lowering of the velocity impulse is caused by collision of the wheel with the step S or the brake operation by the driver. Then, if it is determined that the wheel has collided with the step S by detecting the lowering of the velocity impulse caused by the brake operation by the driver, the collision with the step S comes to be erroneously determined.

Further, when the vehicle V is stopped in a state in which the wheel has collided with the step S, the wheel of the vehicle V becomes in a state in which the wheel has collided with the step S before starting and in which the wheel of the stationary vehicle V is in contact with the step S. When the wheel has collided with the step S before staring, and the vehicle V is started from a state in which the wheel is in contact with the step S, the running of the vehicle Vis obstructed by the step S. Therefore, when the vehicle Vis started and passes over the step S, the set value of the driving force set by the braking/driving calculation unit 422 for passing over the step S may be required to be greater than the set value set in step S120 of the previous control period.

In this manner, when the vehicle V is started from a state in which the wheel is in contact with the step S, the braking/driving calculation unit 422 may need to change the set value of the driving force. Therefore, it is required to accurately detect that the wheel is in a state of being in contact with the step S before starting.

By the way, when the vehicle V is started from a state in which the wheel is in contact with the step S, the vehicle speed is 0 until the vehicle V begins running, that is, until the wheel begins running on the step S. Therefore, the velocity impulse does not change from 0 until the wheel begins running on the step S. Then, when the vehicle V begins running, and the wheel begins running on the step S, the velocity impulse increases from 0.

However, when the wheel of the vehicle V has not collided with the step S before starting, and the vehicle V is started from a state in which the wheel is not in contact with the step S, the vehicle speed is also 0 until the vehicle V begins running. Therefore, when the vehicle Vis started from a state in which the wheel is not in contact with the step S, the velocity impulse also does not change from 0 until the wheel begins running on the step S. Then, when the vehicle V begins running, the velocity impulse increases from 0.

In this manner, the velocity impulse is 0 in magnitude until the vehicle V begins running regardless of whether the wheel is in a state of being in contact with the step S, and increases from 0 when the vehicle V begins running.

Therefore, the state in which the wheel is in contact with the step S before starting cannot be accurately detected by a method of detecting a change in velocity impulse. Further, even if an increase in velocity impulse is detected, it cannot be determined whether the vehicle V started from a state in which the wheel is in contact with the step S or from a state in which the wheel is not in contact with the step S.

Here, through intensive study, the inventors focused on the fact that the driving force and the braking force differ between when the velocity impulse lowers due to collision of the wheel with the step S and when the velocity impulse lowers due to the braking operation by the driver. Then, the inventors studied accurately detecting that the wheel of the vehicle V is in contact with or collides with the step S based on a difference in driving force and braking force. The difference in driving force and braking force between when the velocity impulse lowers due to collision of the wheel with the step S and when the velocity impulse lowers due to the braking operation by the driver will be described with reference to FIG. 7.

During execution of the automatic parking process of repeatedly executing the process of step S100 to step S140, the vehicle speed control unit 42 adjusts the driving force and the braking force in order to run the subject vehicle at the target speed. Then, for running the vehicle V at a constant vehicle speed or with acceleration during execution of the automatic parking process, the braking/driving calculation unit 422 sets the set value of the driving force to equal to or greater than the set value of the braking force. On the other hand, for stopping or decelerating the vehicle V during execution of the automatic parking process, the braking/driving calculation unit 422 increases the set value of the braking force to more than the set value of the driving force.

Further, when the wheel collides with the step S resulting in lowering in vehicle speed while the vehicle Vis running at the target speed during execution of the automatic parking process, the vehicle speed deviates from the target speed. Then, the automatic parking control device 40 repeatedly executes the process of step S100 to step S140 so that the braking/driving calculation unit 422 increases the set value of the driving force and decreases the set value of the braking force such that the vehicle speed approaches the target speed.

Therefore, when the velocity impulse lowers due to collision of the wheel with the step S during execution of the automatic parking process, the braking/driving calculation unit 422 gradually increases the set value of the driving force and gradually increases the set value of the braking force as the velocity impulse gradually lowers. Therefore, as shown in FIG. 7, when the velocity impulse lowers due to collision of the wheel with the step S, a total value calculated by adding the driving force output by the driving system 50 to the braking force output by the braking system 60 increases as the velocity impulse lowers. This is because when the vehicle V is to be accelerated, the braking/driving calculation unit 422 sets the set value of the driving force to be larger than the set value of the braking force.

On the other hand, although not shown, when the velocity impulse lowers due to the braking operation by the driver, the total value calculated by adding the driving force output by the driving system 50 to the braking force output by the braking system 60 decreases as the velocity impulse lowers. This is because when the vehicle V is to be decelerated or stopped, the braking/driving calculation unit 422 sets the set value of the braking force to be larger than the set value of the driving force.

In this manner, the driving force and the braking force differ between when the velocity impulse lowers due to collision of the wheel with the step S and when the velocity impulse lowers due to the braking operation by the driver. Here, the inventors focused on the fact that the impulse acting on the vehicle V can is calculated based on the driving force and the braking force in addition to based on the vehicle speed.

Then, the inventors found that when the vehicle speed changes by passing over the step S, a difference occurs between the velocity impulse that is calculated based on the vehicle speed and the impulse that is calculated based on the driving force and the braking force. Further, the inventors found that when starting the vehicle V from a state in which the wheel is in contact with the step S, a difference also occurs between the velocity impulse that is calculated based on the vehicle speed and the impulse that is calculated based on the driving force and the braking force. Hereinafter, the impulse calculated based on the driving force and the braking force is referred to as defined as a braking/driving impulse.

Therefore, the inventors studied on using the braking/driving impulse as a detection method of the collision of the wheel with the step S and the wheel before starting being in a state of being in contact with the step S. The braking/driving impulse is the impulse acting on the vehicle V and also is calculated based on the driving force output by the driving system 50 and the braking force output by the braking system 60 for running the vehicle V.

In the vehicle control device 1 of the present embodiment, the impulse calculation unit 43 calculates the braking/driving impulse in addition to the velocity impulse. The braking/driving impulse acting on the vehicle V when the vehicle V runs on the road surface for a predetermined time is calculated by calculating the value obtained by adding the driving force output by the driving system 50 to the braking force output by the braking system 60. For example, when the driving force output by the driving system 50 is drive F1, and the braking force output by the braking system 60 is brake F2, the braking/driving impulse is calculated according to equation 2 shown below. The impulse calculation unit 43 calculates, as the impulse information, the braking/driving impulse based on equation 2.

Braking/driving impulse=∫(drive F1+brake F2) (2)

When a sum of drive F1 and brake F2 becomes smaller than 0 because drive F1 becomes smaller than brake F2, the braking/driving impulse becomes smaller than 0. That is, when adjusting drive F1 and brake F2 in order to decelerate or stop the vehicle V, the braking/driving impulse becomes smaller than 0.

On the other hand, when the sum of drive F1 and brake F2 becomes larger than 0 because drive F1 becomes larger than brake F2, the braking/driving impulse becomes larger than 0. That is, when drive F1 and brake F2 are adjusted in order to accelerate the vehicle V, the braking/driving impulse becomes larger than 0.

Further, for example, in a state in which drive F1 and brake F2 are the same in magnitude, and the vehicle V is running at a constant speed without acceleration and deceleration or is stationary, the braking/driving impulse becomes 0.

Drive F1 may be calculated based on the set value set by the braking/driving calculation unit 422, that is, based on the target number of revolutions of the motor for running, or may be calculated based on a measurement value of the output torque of the motor for running detected by the torque sensor 34. Further, brake F2 may be calculated based on the set value set by the braking/driving calculation unit 422, that is, based on the target fluid pressure of the brake fluid supplied to the wheel cylinder. Further, brake F2 may be calculated based on a measurement value of the braking force occurring in the braking system 60 detected by the brake sensor 35.

In calculating the braking/driving impulse, an error of the calculated braking/driving impulse can be suppressed by using the measurement value detected by the torque sensor 34 and the measurement value detected by the brake sensor 35, compared to by using the respective set values of the driving force and the braking force set by the braking/driving calculation unit 422.

In this manner, similarly to the velocity impulse, the braking/driving impulse rises in magnitude when accelerating the vehicle V and lowers in magnitude when decelerating the vehicle V. Then, when the vehicle V is not subjected to an outside force, the velocity impulse and the braking/driving impulse become substantially the same in magnitude. That is, when the vehicle V is not influenced by disturbance, the velocity impulse and the braking/driving impulse become substantially the same in magnitude. This is because when not influenced by disturbance, the change of the vehicle speed is determined by the change of the driving force and the change of the braking force.

However, as described above, when the wheel of the running vehicle V running on the road surface collides with the step S, and the vehicle speed lowers, the velocity impulse lowers as the vehicle speed lowers. On the other hand, the braking/driving impulse is not influenced by the change of the vehicle speed even when the wheel collides with the step S, and the vehicle speed lowers, unless the driving force and the braking force lower. Further, as shown in FIG. 7, even when the wheel collides with the step S, and the vehicle speed and the velocity impulse lower, the braking/driving impulse increases in magnitude when a value calculated by adding the driving force to the braking force changes to become larger.

Therefore, when the running vehicle V is subjected to a force from the step S which is external to the vehicle V, the velocity impulse and the braking/driving impulse come to be different from each other in magnitude. That is, when the vehicle V is influenced by disturbance, the velocity impulse comes to deviate from the braking/driving impulse in magnitude. In other words, the impulse received from disturbance causes the velocity impulse to deviate from the braking/driving impulse in magnitude.

Further, as described above, the velocity impulse is 0 in a state in which the vehicle Vis stationary. Therefore, when starting the vehicle V from a state in which the wheel of the vehicle V has collided with the step S, the velocity impulse is 0 until the vehicle V begins running, even when increasing the driving force in order to start the vehicle V. On the other hand, the braking/driving impulse increases in magnitude from 0 even in a state in which the vehicle V is stationary, by increasing the driving force in order to start the vehicle V.

Therefore, when starting the vehicle V from a state in which the wheel has collided with the step S, the velocity impulse and the braking/driving impulse come to be different from each other in magnitude. That is, when the vehicle V is subjected to a force from the step S which is external to the vehicle V, the braking/driving impulse comes to deviate from the velocity impulse in magnitude. In other words, the impulse received from disturbance causes the velocity impulse to deviate from the braking/driving impulse in magnitude. Hereinafter, the impulse received from the step S which becomes a factor for disturbance when the wheel of the vehicle V running on the road surface collides with the step S and when the vehicle V is started from a state in which the wheel has collided with the step S is defined as a disturbance impulse. The disturbance impulse is calculated by subtracting the braking/driving impulse from the velocity impulse, as shown in equation 3 shown below.

Disturbance impulse=velocity impulse-braking/driving impulse (3)

From the above, the inventors found that the collision of the wheel with the step S and the state in which the wheel before starting is in contact with the step S can be detected based on whether the velocity impulse deviates from the braking/driving impulse in magnitude.

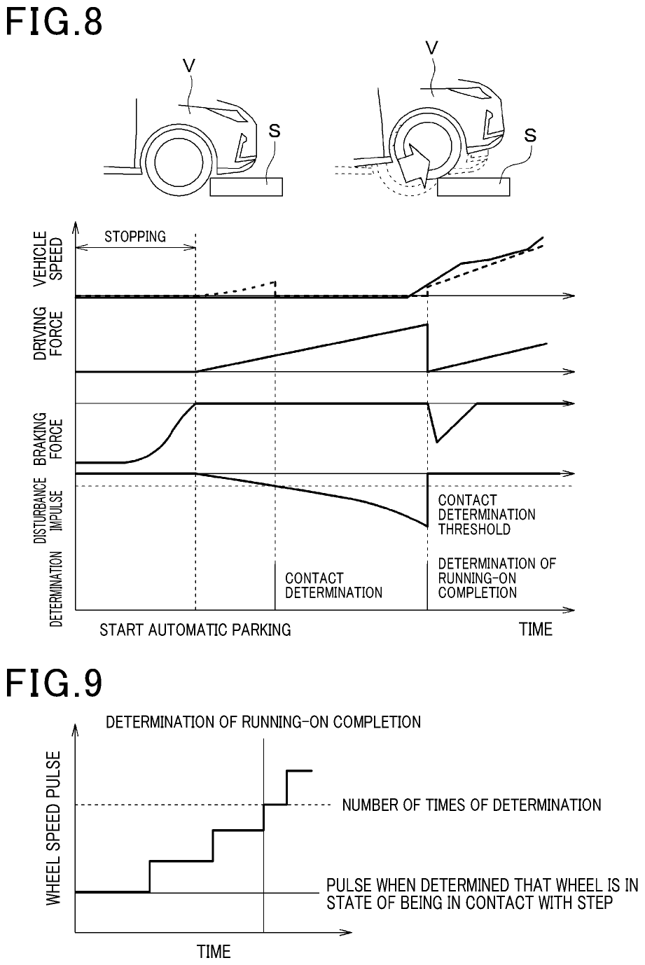

Therefore, in the automatic parking control device 40 of the present embodiment, the impulse calculation unit 43 calculates the velocity impulse and the braking/driving impulse, and the step determination unit 44 determines, based on the velocity impulse and the braking/driving impulse calculated by the impulse calculation unit 43, the collision with the step S and the state of being in contact with the step S. The determination method for the collision of the wheel with the step S and whether the wheel before starting is in a state of being in contact with the step S will be described with reference to FIG. 3, FIG. 8, and FIG. 9.

In step S12, the impulse calculation unit 43 calculates the velocity impulse and the braking/driving impulse acting on the vehicle V when passing over the step S, based on various pieces of information acquired from the sensor unit 30. Specifically, the impulse calculation unit 43 differentiates the detection value detected by the speed sensor 31 to calculate the acceleration of the vehicle V, and calculates the velocity impulse based on the calculated acceleration of the vehicle V and a previously set weight of the vehicle V. Further, the impulse calculation unit 43 calculates the braking/driving impulse based on the output torque of the motor for running detected by the torque sensor 34 and the braking force occurring in the braking system 60 detected by the brake sensor 35. The impulse calculation unit 43 transmits information of the calculated velocity impulse and information of the calculated braking/driving impulse to the step determination unit 44.

In the following step S14, the step determination unit 44 determines whether the vehicle V is running, based on the information acquired from the sensor unit 30. For example, the step determination unit 44 determines that the vehicle V is running when the detection value detected by the speed sensor 31 is not 0, and does not determine that the vehicle V is running when the detection value detected by the speed sensor 31 is 0. The step determination unit 44 executes the process of step S16 in response to not determining that the vehicle Vis running, and executes the process of step S32 in response to determining that the vehicle V is running.

In step S16, the step determination unit 44 determines whether the wheel of the vehicle V before starting is in a state of being in contact with the step S, based on information of the velocity impulse and information of the braking/driving impulse received from the impulse calculation unit 43. Specifically, the step determination unit 44 calculates, based on information of the velocity impulse and information of the braking/driving impulse, the disturbance impulse that is a difference between the velocity impulse and the braking/driving impulse, and determines whether the wheel of the vehicle V before starting is in a state of being in contact with the step S based on the calculated disturbance impulse. Then, in response to determining that the wheel of the vehicle V before starting is in a state of being in contact with the step S, the automatic parking control device 40 executes the process of step S18 and later.

Further, when it is determined that the vehicle V is running, the step determination unit 44 determines in step S32 whether the wheel of the running vehicle V has collided with the step S based on information of the velocity impulse and information of the braking/driving impulse received from the impulse calculation unit 43. Specifically, the step determination unit 44 calculates, based on information of the velocity impulse and information of the braking/driving impulse, the disturbance impulse that is the difference between the velocity impulse and the braking/driving impulse, and determines whether the wheel of the running vehicle V has collided with the step S based on the calculated disturbance impulse. Then, when it is determined that the wheel of the running vehicle V has collided with the step S, the automatic parking control device 40 executes the process of step S34 and later.

A method in which the step determination unit 44 determines whether the wheel of the vehicle V before starting is in a state of being in contact with the step S based on the disturbance impulse and a control process when the wheel of the vehicle V before starting was determined to be in a state of being in contact with the step S will be described with reference to FIG. 8.

As shown in FIG. 8, when the vehicle V is stationary before starting, the vehicle speed and the driving force are 0. Further, when the vehicle Vis in stationary before starting, the braking system 60 outputs the braking force for stopping the vehicle V.

Then, for example, when the automatic parking control device 40 executes the process of the automatic parking action in response to the start signal of automatic parking being input, the automatic parking is started based on various set values calculated by the braking/driving calculation unit 422. For example, the target speed is set such that the vehicle speed gradually rises with the passage of time. Further, the set value of the driving force is set so as to gradually rise with the passage of time in order to bring the vehicle speed closer to the target speed. Accordingly, the running system outputs the driving force. Note that of the vehicle speed shown in FIG. 8, the broken line indicates the target speed, and the solid line indicates the speed of the vehicle V detected by the speed sensor 31. Further, the set value of the braking force is set to 0. Accordingly, the braking system 60 terminates the output of the braking force.

Here, as shown in FIG. 8, it is assumed that the wheel of the vehicle V before starting is in contact with the step S, and start of the vehicle Vis obstructed by the step S, so that the vehicle V cannot start because of the step S which becomes a factor for disturbance even when the motor for running outputs the driving force. In this case, the vehicle speed maintains 0 immediately after the motor for running has output the driving force. Therefore, the velocity impulse maintains 0 in a state in which start of the vehicle Vis obstructed by the step S.

Further, when start of the vehicle Vis obstructed by the step S, the vehicle speed detected by the speed sensor 31 and the target speed deviate from each other. Then, the deviation amount between the vehicle speed detected by the speed sensor 31 and the target speed gradually increases with the passage of time. Therefore, the braking/driving calculation unit 422 gradually increases the set value of the driving force with the passage of time. Accordingly, the driving force output by the driving system 50 gradually increases with the passage of time. Then, the braking/driving impulse increases with the passage of time.

Therefore, the disturbance impulse calculated by subtracting the braking/driving impulse from the velocity impulse decreases in such a manner as to depart from 0 with the passage of time as shown in FIG. 8. That is, the absolute value of the disturbance impulse increases with the passage of time.

Here, the step determination unit 44 determines, in step S16, that the wheel of the vehicle V before starting is in a state of being in contact with the step S when the disturbance impulse becomes not more than a previously set contact determination threshold. In other words, the step determination unit 44 determines that the wheel of the vehicle V before starting is in a state of being in contact with the step S when the absolute value of the difference between the velocity impulse and the braking/driving impulse becomes equal to or greater than the contact determination threshold.

The contact determination threshold is a predetermined threshold previously set in order to determine whether the vehicle Vis in a state of being in contact with the step S, and is set based on, for example, an experimental result obtained by previously performing an experiment of starting the vehicle V in a state in which the step S is brought into contact with the wheel. Further, the contact determination threshold is set, in step S16, depending on the height of the step S with which contact is desired to be detected.

In this manner, the vehicle control device 1 of the present embodiment can accurately detect that the wheel of the vehicle V before starting is in contact with the step S by determining that the wheel of the vehicle V before starting is in a state of being in contact with the step S based on the disturbance impulse. Then, it can be detected that the vehicle V has started from a state in which the wheel is in contact with the step S.

Further, the contact determination threshold of the present embodiment is set so as to be changeable depending on the roughness of the road surface. For example, in the step determination unit 44, a base threshold to serve as a reference threshold is previously defined, and a predetermined additional value is added to the base threshold depending on the roughness of the road surface such that the contact determination threshold is changeable. The base threshold is set depending on, for example, the height of the step S.

Then, the contact determination threshold is set so as to be changeable depending on the roughness of the road surface between a good road threshold in which the predetermined additional value is added when the roughness of the road surface is flat and a bad road threshold in which the predetermined additional value is added when the roughness of the road surface is rougher than flatness and has an uneven shape. The predetermined additional value added when setting the good road threshold is set to be smaller than the predetermined additional value added when setting the bad road threshold. That is, the good road threshold is smaller than the bad road threshold. The step determination unit 44 detects the roughness of the road surface, and sets the contact determination threshold to one of the good road threshold and the bad road threshold.

The step determination unit 44 may detect the roughness of the road surface, for example, based on the speed of the vehicle V detected by the speed sensor 31 when finally having run, before the vehicle V terminates running. For example, when a deviation between the speed of the vehicle V detected by the speed sensor 31 when finally having run and the target speed when finally having run is relatively small, the step determination unit 44 determines that the roughness of the road surface is flat and sets the contact determination threshold to the good road threshold. On the other hand, for example, when the deviation between the speed of the vehicle V detected by the speed sensor 31 when finally having run and the target speed when finally having run is relatively large, the step determination unit 44 determines that the roughness of the road surface has an uneven shape and sets the contact determination threshold to the bad road threshold which is larger than the good road threshold. In the present embodiment, the speed sensor 31 functions as a road surface detection unit that detects the roughness of the road surface.

A reason why the roughness of the road surface can be determined based on the deviation between the speed of the vehicle V detected by the speed sensor 31 and the target speed in this manner is that resistance received from the road surface when the vehicle V runs on the road surface is reduced when the road surface is flat compared to when the road surface has an uneven shape. That is, it is because when the resistance received from the road surface is small, the speed of the vehicle V can be easily brought closer to the target speed.

Note that the step determination unit 44 may detect the roughness of the road surface based on information other than the speed of the vehicle V detected by the speed sensor 31. For example, the step determination unit 44 may detect the roughness of the road surface based on the acceleration in the upper and lower direction of the vehicle V detected by the acceleration sensor 32. In this case, for example, when the acceleration in the upper and lower direction of the vehicle V detected by the acceleration sensor 32 when finally having run is a predetermined value or less, the step determination unit 44 may determine that the roughness of the road surface is flat and set the contact determination threshold to the good road threshold. On the other hand, for example, when the acceleration in the upper and lower direction of the vehicle V detected by the acceleration sensor 32 when finally having run is larger than the predetermined value, the step determination unit 44 determines that the roughness of the road surface has an uneven shape, and sets the contact determination threshold to the bad road threshold.

Further, the step determination unit 44 may detect the roughness of the road surface based on the image of the road surface taken by the camera of the surroundings monitoring unit 10 or based on reflected waves from the road surface acquired by each of the sonar, the millimeter-wave radar, and the LIDAR of the surroundings monitoring unit 10.

When the acceleration sensor 32 detects the roughness of the road surface, the acceleration sensor 32 functions as the road surface detection unit that detects the roughness of the road surface. Further, when the surroundings monitoring unit 10 detects the roughness of the road surface, the surroundings monitoring unit 10 functions as the road surface detection unit that detects the roughness of the road surface.

In response to determining in step S16 that the wheel of the vehicle V before starting is in a state of being in contact with the step S, the step determination unit 44 transmits information of the determination result to the braking/driving calculation unit 422. In response to receiving information that the wheel of the vehicle V before starting is in a state of being in contact with the step S from the step determination unit 44, the braking/driving calculation unit 422 executes the process of step S18.

In step S18, the braking/driving calculation unit 422 calculates the driving force necessary for passing over the step S based on the determination result of the step determination unit 44. For example, the braking/driving calculation unit 422 calculates, as the driving force necessary for passing over the step S, a value calculated by increasing the set value set in step S120 of the previous control period in the automatic parking action by a previously set increase amount.

Then, in step S20, the braking/driving calculation unit 422 transmits information of the calculated driving force necessary for passing over the step S to the driving ECU 51 of the driving system 50.

Accordingly, the driving force output by the motor for running becomes larger than the set value set in response to the start signal of automatic parking being input.

In the following step S22, the step determination unit 44 detects the quantity of pulse signals based on pulse signals output by the speed sensor 31. The step determination unit 44 detects the quantity of pulse signals received from the speed sensor 31 after it was determined in step S16 that the wheel is in a state of being in contact with the step S. Then, the step determination unit 44 determines whether the wheel of the vehicle V has run on the step S, based on whether the quantity of pulse signals received is equal to or greater than the number of times of determination previously set.

A reason why it can be determined whether the wheel has run on the step S based on the quantity of received pulse signals will be described with reference to FIG. 9.

As described above, the speed sensor 31 outputs pulse signals shown in FIG. 9 the designed number of times depending on the revolution angle of the wheel every time the wheel revolves once. Therefore, the revolution angle of the wheel is calculated based on the number of pulse signals. Then, a proceeding distance of the vehicle V is calculated based on the revolution angle of the wheel. Therefore, the step determination unit 44 can determine whether the vehicle V has proceeded and has run on the step S based on the quantity of detected pulse signals. Note that the pulse width of the pulse signal decreases as the revolution speed of the wheel is faster.

In the present embodiment, the number of times of determination for determining whether the wheel of the vehicle V has run on the step S is set to 3. Therefore, the step determination unit 44 determines that the wheel has run on the step S when the pulse signal received from the speed sensor 31 after it was determined that the wheel is in a state of being in contact with the step S is received three times. Note that the number of times of determination for determining whether the wheel of the vehicle V has run on the step S is not limited to 3, and may be less than 3 or more than 3. The more the number of times of determination, the longer a time until it is determined that the wheel has run on the step S when the wheel has revolved, but an erroneous determination attributable to a slipping of the wheel can be prevented.

Further, in the present embodiment, it is determined whether the wheel has run on the step S, based on the quantity of pulse signals received from the speed sensor 31 provided to each of the four wheels. For example, the step determination unit 44 may determine that the wheel has run on the step S when the pulse signal was received the number of times of determination from two of the four speed sensors 31. Alternatively, the step determination unit 44 may determine that the wheel has run on the step S when the pulse signal was received the number of times of determination from all of the four speed sensors 31.

The automatic parking control device 40 repeatedly executes the process of step S18 to step S24 until it is determined that the wheel of the vehicle V has run on the step S. Then, in response to determining in step S24 that the wheel of the vehicle V has run on the step S, the step determination unit 44 transmits information of the determination result to the braking/driving calculation unit 422. In response to receiving from the step determination unit 44 information that the wheel has run on the step S, the braking/driving calculation unit 422 executes the process of step S26.

In this manner, the vehicle control device 1 of the present embodiment can accurately detect that the wheel has run on the step S by determining that the wheel of the vehicle V having been in contact with the step S before starting has run on the step S based on the number of pulse signals received from the speed sensor 31.

In step S26, the braking/driving calculation unit 422 calculates the driving force immediately after having run on the step S and the braking force immediately after having run on the step S, based on the determination result of the step determination unit 44. For example, the braking/driving calculation unit 422 calculates, as the driving force immediately after having run on the step S, a value calculated by reducing the driving force set in step S18 for passing over the step S by a previously set decrease amount. In the present embodiment, the braking/driving calculation unit 422 sets the set value of the driving force immediately after having run on the step S to 0.

Further, the braking/driving calculation unit 422 calculates, as the braking force immediately after having run on the step S, a value obtained by increasing the braking force set to be small in response to the vehicle speed detected by the speed sensor 31 deviating from the target speed by a previously set increase amount.

Then, in step S28, the braking/driving calculation unit 422 transmits information of the calculated driving force immediately after having run on the step S to the driving ECU 51 of the driving system 50, and transmits information of the calculated braking force immediately after having run on the step S to the braking ECU 61 of the braking system 60.

Accordingly, the driving force output by the driving system 50 becomes smaller than the set value set in step S18. Specifically, the driving force output by the driving system 50 immediately after having run on the step S becomes 0, as shown in FIG. 8.

Further, the braking force output by the braking system 60 becomes larger than the set value set in step S18. Specifically, the driving force output by the braking system 60 immediately after having run on the step S gradually increases with the passage of time, as shown in FIG. 8. By controlling the driving force and the braking force after having run on the step S in this manner, abrupt acceleration of the vehicle V after the vehicle V has run on the step S can be suppressed.

Then, in step S30, the automatic parking control device 40 controls the vehicle V for a previously determined time by the driving force and the braking force set in step S26 and thereafter returns to the control before it is determined that the wheel of the vehicle V before starting is in contact with the step S. That is, the automatic parking control device 40 performs the process of step S100 to step S140 and performs the automatic parking action.

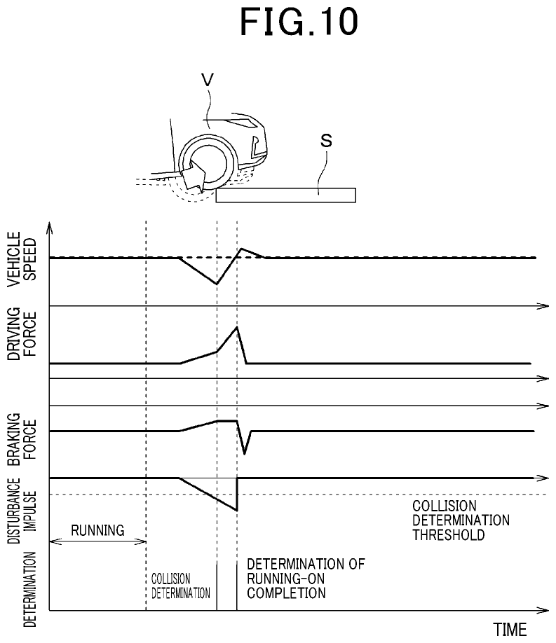

Subsequently, a method in which the step determination unit 44 determines whether the wheel of the running vehicle V has collided with the step S based on the disturbance impulse and a control process when it was determined that the wheel of the running vehicle V has collided with the step S will be described with reference to FIG. 10.

When the target speed is set such that the vehicle V runs at a constant speed in the process of the automatic parking action, the driving force output by the driving system 50 and the braking force output by the braking system 60 become constant, as shown in FIG. 10. In this case, the velocity impulse and the braking/driving impulse maintain 0. Here, as shown in FIG. 10, in response to the wheel of the running vehicle V colliding with the step S, the vehicle speed lowers than the target speed. Note that of the vehicle speed shown in FIG. 10, the broken line indicates the target speed, and the solid line indicates the speed of the vehicle V detected by the speed sensor 31.

Accordingly, the vehicle speed detected by the speed sensor 31 and the target speed deviate from each other. Then, the deviation amount between the vehicle speed detected by the speed sensor 31 and the target speed gradually increases with the passage of time. Further, the velocity impulse lowers in magnitude with lowering of the vehicle speed.

Then, the braking/driving calculation unit 422 gradually increases the set value of the driving force and gradually decreases the set value of the braking force with the passage of time, when the vehicle speed detected by the speed sensor 31 and the target speed deviate from each other. Accordingly, the driving force output by the driving system 50 gradually increases with the passage of time. Further, the braking force output by the braking system 60 gradually increases with the passage of time. Accordingly, the braking/driving impulse increases with the passage of time.

Therefore, the disturbance impulse calculated by subtracting the braking/driving impulse from the velocity impulse decreases in such a manner as to depart from 0 with the passage of time, as shown in FIG. 10. That is, the absolute value of the disturbance impulse increases with the passage of time.

Here, the step determination unit 44 determines, in step S32, that the wheel of the running vehicle V has collided with the step S when the disturbance impulse becomes not more than a previously set collision determination threshold. In other words, the step determination unit 44 determines that the wheel of the running vehicle V has collided with the step S when the absolute value of the difference between the velocity impulse and the braking/driving impulse becomes equal to or greater than the collision determination threshold.

The collision determination threshold is a predetermined threshold previously set for determining whether the wheel of the running vehicle V has collided with the step S, and is set based on, for example, an experimental result obtained by previously performing an experiment in which the wheel of the running vehicle V is collided with the step S. Further, the collision determination threshold is set, in step S32, depending on the height of the step S which it is desired to be detected that the wheel of the running vehicle V has collided with the step S. Note that the collision determination threshold may be set to be the same as the contact determination threshold in magnitude, or may be set to be different from the contact determination threshold in magnitude.

In this manner, the vehicle control device 1 of the present embodiment can accurately detect that the wheel has collided with the step S by determining that the wheel of the running vehicle V has collided with the step S based on the disturbance impulse.

Further, the collision determination threshold of the present embodiment is, similarly to the contact determination threshold, set to be changeable depending on the roughness of the road surface. Specifically, in the step determination unit 44, similarly to the contact determination threshold, a base threshold to serve as a reference threshold is previously defined, and a predetermined additional value is added to the base threshold depending on the roughness of the road surface so that the collision determination threshold is changeable. The step determination unit 44 detects the roughness of the road surface, and sets the collision determination threshold to one of the good road threshold and the bad road threshold. The base threshold is set depending on, for example, the height of the step S.

For example, when the deviation between the speed of the vehicle V detected by the speed sensor 31 when having accelerated the vehicle V and the target speed when finally having run is relatively small, the step determination unit 44 determines that the roughness of the road surface is flat and sets the collision determination threshold to the good road threshold. On the other hand, for example, when the deviation between the speed of the vehicle V detected by the speed sensor 31 when having accelerated the vehicle V and the target speed when finally having run is relatively large, the step determination unit 44 determines that the roughness of the road surface has an uneven shape, and sets the collision determination threshold to the bad road threshold.

Note that the step determination unit 44 may detect the roughness of the road surface based on the acceleration in the upper and lower direction of the vehicle V detected by the acceleration sensor 32 while the vehicle Vis running, and set the collision determination threshold to one of the good road threshold and the bad road threshold based on the detected roughness of the road surface.

Further, the step determination unit 44 may detect the roughness of the road surface based on the image of the road surface taken by the camera of the surroundings monitoring unit 10 while the vehicle V is running, and set the collision determination threshold to one of the good road threshold and the bad road threshold based on the detected roughness of the road surface. Alternatively, the step determination unit 44 may detect the roughness of the road surface based on reflected waves from the road surface acquired by each of the sonar, the millimeter-wave radar, and the LIDAR of the surroundings monitoring unit 10, and set the collision determination threshold to one of the good road threshold and the bad road threshold based on the detected roughness of the road surface.

In response to determining in step S32 that the wheel of the running vehicle V has collided with the step S, the step determination unit 44 transmits information of the determination result to the braking/driving calculation unit 422. In response to receiving from the step determination unit 44 information that the wheel of the running vehicle V has collided with the step S, the braking/driving calculation unit 422 executes the process of step S34.

In step S34, the braking/driving calculation unit 422 calculates the driving force necessary for passing over the step S based on the determination result of the step determination unit 44. For example, the braking/driving calculation unit 422 calculates, as the driving force necessary for passing over the step S, a value obtained by increasing the set value set in step S120 of the previous control period in the automatic parking action by a previously set increase amount.

Then, in step S36, the braking/driving calculation unit 422 transmits information of the calculated driving force necessary for passing over the step S to the driving ECU 51 of the driving system 50.

Accordingly, the driving force output by the motor for running becomes larger than the set value set in step S120 of the previous control period in the automatic parking action. With an increase of the driving force output by the motor for running, the wheel of the vehicle V begins running on the step S, and the vehicle speed rises so as to approach the target speed. Accordingly, the vehicle speed detected by the speed sensor 31 can be brought closer to the target speed. Then, the deviation amount between the vehicle speed detected by the speed sensor 31 and the target speed gradually decreases with the passage of time. Further, the velocity impulse rises in magnitude with a rise of the vehicle speed.

Further, the braking/driving calculation unit 422 sets the set value of the driving force output by the motor for running to be larger than the set value of the driving force set before it is determined that the wheel of the running vehicle V has collided with the step S. Accordingly, the braking/driving impulse increases with the passage of time.

Therefore, the disturbance impulse calculated by subtracting the braking/driving impulse from the velocity impulse increases in such a manner as to approach 0 with the passage of time, as shown in FIG. 10. That is, the absolute value of the disturbance impulse decreases with the passage of time.

In the following step S38, the impulse calculation unit 43 calculates the velocity impulse and the braking/driving impulse acting on the vehicle V when passing over the step S, based on various pieces of information acquired from the sensor unit 30. Specifically, the impulse calculation unit 43 differentiates the detection value detected by the speed sensor 31 to calculate the acceleration of the vehicle V, and calculates the velocity impulse based on the calculated acceleration of the vehicle V and a previously set weight of the vehicle V. Further, the impulse calculation unit 43 calculates the braking/driving impulse based on the output torque of the motor for running detected by the torque sensor 34 and the braking force occurring in the braking system 60 detected by the brake sensor 35. The impulse calculation unit 43 transmits information of the calculated velocity impulse and information of the calculated braking/driving impulse to the step determination unit 44.

In the following step S40, the step determination unit 44 determines whether the wheel of the vehicle V has run on the step S, based on information of the velocity impulse and information of the braking/driving impulse received from the impulse calculation unit 43. Specifically, the step determination unit 44 calculates the braking/driving impulse after it was determined that the wheel has collided with the step S and the disturbance impulse after it was determined that the wheel has collided with the step S, based on information of the braking/driving impulse calculated by the impulse calculation unit 43. Then, the step determination unit 44 determines that the wheel of the vehicle V has run on the step S, when the braking/driving impulse after it was determined that the wheel has collided with the step S became equal to or greater than the disturbance impulse after it was determined that the wheel has collided with the step S.

The automatic parking control device 40 repeatedly executes the process of step S34 to step S40 until it is determined that the wheel of the vehicle V has run on the step S. Then, in response to determining in step S40 that the wheel of the vehicle V has run on the step S, the step determination unit 44 transmits information of the determination result to the braking/driving calculation unit 422. In response to receiving from the step determination unit 44 information that the wheel has run on the step S, the braking/driving calculation unit 422 executes the process of step S42.

In this manner, the vehicle control device 1 of the present embodiment can accurately detect that the wheel has run on the step S by determining that the wheel has run on the step S after the wheel of the running vehicle V collided with the step S based on the velocity impulse and the braking/driving impulse calculated by the impulse calculation unit 43.

In step S42, the braking/driving calculation unit 422 calculates the driving force immediately after having run on the step S and the braking force immediately after having run on the step S, based on the determination result of the step determination unit 44. For example, the braking/driving calculation unit 422 calculates, as the driving force immediately after having run on the step S, a value calculated by reducing the driving force set in step S34 for passing over the step S by a previously set decrease amount. In the present embodiment, the braking/driving calculation unit 422 sets the set value of the driving force immediately after having run on the step S to the driving force immediately before the wheel of the vehicle V collides with the step S.

Further, the braking/driving calculation unit 422 calculates, as the braking force immediately after having run on the step S, a value calculated by increasing the braking force set to be small in response to the vehicle speed detected by the speed sensor 31 deviating from the target speed by a previously set increase amount.

Then, in step S44, the braking/driving calculation unit 422 transmits information of the calculated driving force immediately after having run on the step S to the driving ECU 51 of the driving system 50, and transmits information of the calculated braking force immediately after having run on the step S to the braking ECU 61 of the braking system 60.

Accordingly, the driving force output by the driving system 50 becomes smaller than the set value set in step S34. Specifically, the driving force output by the driving system 50 immediately after having run on the step S gradually decreases so as to become the driving force immediately before the wheel of the vehicle V collides with the step S, as shown in FIG. 10.

Further, the braking force output by the braking system 60 becomes larger than the set value set in step S34. Specifically, the driving force output by the braking system 60 immediately after having run on the step S gradually increases with the passage of time, as shown in FIG. 10. By controlling the driving force and the braking force immediately after having run on the step S in this manner, abrupt acceleration of the vehicle V after the vehicle V has run on the step S can be suppressed, and the vehicle speed can be returned to the vehicle speed before the wheel of the vehicle V collides with the step S.

Then, the automatic parking control device 40 controls the vehicle V for a previously determined time by the driving force and the braking force set in step S42 and thereafter returns to the control before it is determined that the wheel of the vehicle V has collided with the step S. That is, the automatic parking control device 40 performs the process of step S100 to step S140 and performs the automatic parking action.

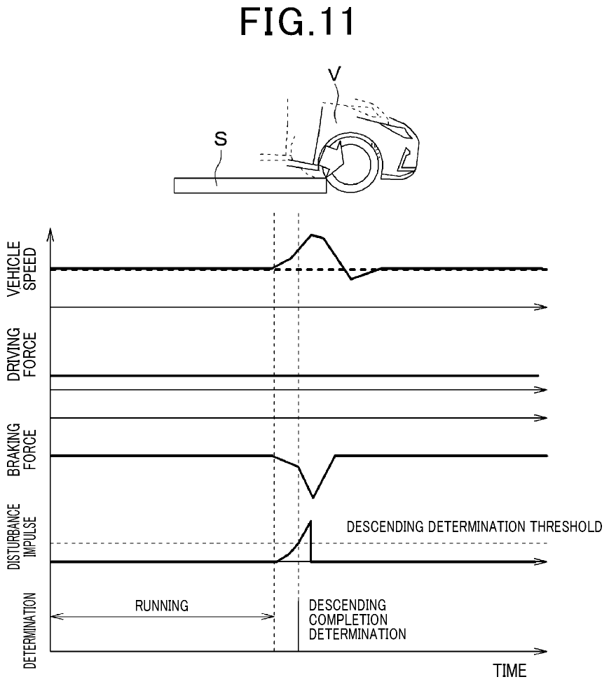

Subsequently, the control process containing the control process executed after the vehicle V has descended from the step S from a state of having run on the step S during the automatic parking action will be described with reference to FIG. 4 and FIG. 11. Note that since the automatic parking process of step S50 shown in FIG. 4 is the same process as the automatic parking process of step S10 shown in FIG. 3, description thereof will be omitted.

As described above, when the vehicle V running on the flat road surface at a constant speed descends from the step S as shown in FIG. 11, potential energy is converted into kinetic energy due to gravity, and the vehicle speed rises. Therefore, in order to prevent the vehicle speed from abruptly rising after the wheel has descended from the step S, the driving force after having descended from the step S needs to be lower than the driving force set before descending from the step S.

Therefore, the automatic parking control device 40 of the present embodiment executes the process of step S52 and later during the automatic parking action and detects that the wheel has descended from the step S, in the control process shown in FIG. 4. Then, when the wheel has descended from the step S, the automatic parking control device 40 decreases the driving force than before descending from the step S.

Specifically, in the automatic parking control device 40 of the present embodiment, the impulse calculation unit 43 calculates the velocity impulse and the braking/driving impulse, and the step determination unit 44 determines, based on the velocity impulse and the braking/driving impulse calculated by the impulse calculation unit 43, that the wheel has descended from the step S.

When the target speed is set, in the process of the automatic parking action, such that the vehicle V runs at a constant speed, the driving force output by the driving system 50 and the braking force output by the braking system 60 become constant, as shown in FIG. 11. In this case, the velocity impulse and the braking/driving impulse maintain 0. Here, as shown in FIG. 11, in response to the wheel of the running vehicle V descending from the step S, the vehicle speed rises than the target speed. Note that of the vehicle speed shown in FIG. 11, the broken line indicates the target speed, and the solid line indicates the speed of the vehicle V detected by the speed sensor 31.

Accordingly, the vehicle speed detected by the speed sensor 31 and the target speed deviate from each other. Then, the deviation amount between the vehicle speed detected by the speed sensor 31 and the target speed gradually increases with the passage of time. Further, the velocity impulse increases in magnitude with a rise of the vehicle speed.

Then, the braking/driving calculation unit 422 gradually increases the set value of the braking force with the passage of time, when the vehicle speed detected by the speed sensor 31 and the target speed deviate from each other. Accordingly, the braking force output by the braking system 60 gradually increases with the passage of time. Then, the braking/driving impulse increases with the passage of time.

Therefore, the disturbance impulse calculated by subtracting the braking/driving impulse from the velocity impulse increases in such a manner as to depart from 0 with the passage of time, as shown in FIG. 11. That is, the absolute value of the disturbance impulse increases with the passage of time.

Here, the step determination unit 44 determines, in step S54, that the wheel of the running vehicle V has descended from the step S when the disturbance impulse becomes not more than a previously set descending determination threshold. In other words, the step determination unit 44 determines that the wheel of the running vehicle V has descended from the step S when the absolute value of the difference between the velocity impulse and the braking/driving impulse becomes equal to or greater than the descending determination threshold.

The descending determination threshold is a predetermined threshold previously set for determining whether the wheel of the running vehicle V has descended from the step S, and is set based on, for example, an experimental result obtained by previously performing an experiment in which the wheel of the running vehicle V descends from the step S. Further, the descending determination threshold is set, in step S54, depending on the height of the step S which it is desired to be detected that the wheel of the running vehicle V has descended from the step S. Note that the descending determination threshold may be set to be the same as the contact determination threshold and the collision determination threshold in magnitude, or may be set to be different from the contact determination threshold and the collision determination threshold in magnitude.

In this manner, the vehicle control device 1 of the present embodiment can accurately detect that the wheel has descended from the step S by determining that the wheel of the running vehicle V has descended from the step S based on the disturbance impulse.

Further, the descending determination threshold of the present embodiment is, similarly to the contact determination threshold and the collision determination threshold, set to be changeable depending on the roughness of the road surface. Specifically, in the step determination unit 44, similarly to the contact determination threshold and the collision determination threshold, a base threshold to serve as a reference threshold is previously defined, and a predetermined additional value is added to the base threshold depending on the roughness of the road surface so that the descending determination threshold is changeable. The step determination unit 44 detects the roughness of the road surface, and sets the descending determination threshold to one of the good road threshold and the bad road threshold. The base threshold is set depending on, for example, the height of the step S.

For example, when the deviation between the speed of the vehicle V detected by the speed sensor 31 when having accelerated the vehicle V and the target speed when finally having run is relatively small, the step determination unit 44 determines that the roughness of the road surface is flat and sets the descending determination threshold to the good road threshold. On the other hand, for example, when the deviation between the speed of the vehicle V detected by the speed sensor 31 when having accelerated the vehicle V and the target speed when finally having run is relatively large, the step determination unit 44 determines that the roughness of the road surface has an uneven shape, and sets the descending determination threshold to the bad road threshold.

Note that the step determination unit 44 may detect the roughness of the road surface based on the acceleration in the upper and lower direction of the vehicle V detected by the acceleration sensor 32 while the vehicle V is running, and set the descending determination threshold to one of the good road threshold and the bad road threshold based on the detected roughness of the road surface.

Further, the step determination unit 44 may detect the roughness of the road surface based on the image of the road surface taken by the camera of the surroundings monitoring unit 10 while the vehicle V is running, and set the descending determination threshold to one of the good road threshold and the bad road threshold based on the detected roughness of the road surface. Alternatively, the step determination unit 44 may detect the roughness of the road surface based on reflected waves from the road surface acquired by each of the sonar, the millimeter-wave radar, and the LIDAR of the surroundings monitoring unit 10, and set the descending determination threshold to one of the good road threshold and the bad road threshold based on the detected roughness of the road surface.

In response to determining in step S54 that the wheel of the running vehicle V has descended from the step S, the step determination unit 44 transmits information of the determination result to the braking/driving calculation unit 422. In response to receiving, from the step determination unit 44, information that the wheel of the running vehicle V has descended from the step S, the braking/driving calculation unit 422 executes the process of step S56.

In step S56, the braking/driving calculation unit 422 calculates the braking force immediately after having descended from the step S, based on the determination result of the step determination unit 44. For example, the braking/driving calculation unit 422 calculates, as the braking force immediately after having descended from the step S, a value obtained by increasing the braking force immediately before it is determined that the wheel has descended from the step S by a previously set increase amount.

Then, in step S58, the braking/driving calculation unit 422 transmits information of the calculated braking force immediately after having descended from the step S to the braking ECU 61 of the braking system 60.

Accordingly, the braking force output by the braking system 60 becomes smaller than the braking force immediately before it is determined that the wheel has descended from the step S. Specifically, the braking force output by the driving system 60 immediately after having descended from the step S gradually increases with the passage of time, as shown in FIG. 11. By controlling the braking force after having descended from the step S in this manner, abrupt acceleration of the vehicle V after the vehicle V has descended from the step S can be suppressed.

Then, the automatic parking control device 40 controls, in step 60, the vehicle V for a previously determined time by the braking force set in step S56 and thereafter returns to the control before it is determined that the wheel of the vehicle V has collided with the step S. That is, the automatic parking control device 40 performs the process of step S100 to step S140 and performs the automatic parking action.

As described above, the vehicle control device 1 of the present embodiment includes: the impulse calculation unit 43 that calculates the impulse acting on the vehicle V when the vehicle V passes over the step S and outputs the impulse information; and the step determination unit 44 that determines the passage over the step S based on the impulse information output by the impulse calculation unit 43. The impulse calculation unit 43 calculates, as the impulse information, the velocity impulse based on the vehicle speed when passing over the step S and the braking/driving impulse based on the driving force and the braking force when passing over the step S. The step determination unit 44 determines the passage over the step S based on the difference between the velocity impulse and the braking/driving impulse calculated by the impulse calculation unit 43.

As described above, when the vehicle speed changes when passing over the step S, a difference occurs between the velocity impulse and the braking/driving impulse. Therefore, the passage over the step S can be accurately determined by the step determination unit 44 determining the passage over the step S based on the difference between the velocity impulse and the braking/driving impulse, compared to when the passage over the step S is determined based on a change of the vehicle speed.

Further, according to the above-described embodiment, advantageous effects listed below can be achieved.
(1) In the above-described embodiment, the braking/driving calculation unit 422 calculates the driving force and the braking force for the wheel starting from a state of stationary while being in contact with step S and running on the step S, when the wheel has been stationary while being in contact with step S before starting. The impulse calculation unit 43 calculates, based on the driving force and the braking force calculated by the braking/driving calculation unit 422, the velocity impulse and the braking/driving impulse when the vehicle V starts from a state in which the wheel is stationary while being in contact with the step S. The step determination unit 44 determines that the vehicle V is in contact with the step S, when the difference between the velocity impulse and the braking/driving impulse is equal to or greater than the contact determination threshold.

Thus, the vehicle control device 1 can accurately detect that the wheel of the vehicle V before starting is in contact with the step S, by determining that the wheel of the vehicle V before starting is in a state of stationary while being in contact with the step S based on the difference between the velocity impulse and the braking/driving impulse.
(2) In the above-described embodiment, the speed sensor 31 that detects the vehicle speed and outputs information corresponding to the detected vehicle speed is included. The step determination unit 44 determines, based on the information corresponding to the vehicle speed output by the speed sensor 31, that the vehicle V has started from a state in which the wheel is stationary while being in contact with step S, and has run on the step S.

For preventing the vehicle speed from abruptly rising, it is required to lower the driving force immediately after the wheel has run on the step S compared to the set value set for passing over the step S. Further, it is required to raise the braking force immediately after the wheel has run on the step S compared to the set value set for passing over the step S.

On the other hand, according to the vehicle control device 1 of the present embodiment in which the step determination unit 44 determines that the wheel has run on the step S, the driving force and the braking force immediately after the wheel has run on the step S can be adjusted.
(3) In the above-described embodiment, the speed sensor 31 is provided to each of the four wheels of the vehicle V. The step determination unit 44 determines, based on the information corresponding to the vehicle speed output by each of the four speed sensors 31, that the vehicle V has started from a state in which the wheel is stationary while being in contact with step S, and has run on the step S.

Thus, determination accuracy of running on the step S can be improved, compared to when it is determined that the vehicle V has run on the step S based on the information corresponding to the vehicle speed output by one of the speed sensors 31.
(4) In the above-described embodiment, the speed sensor 31 is provided to the wheel of the vehicle V and outputs pulse signals of the quantity depending on the revolution angle of the wheel. The step determination unit 44 determines, in response to receiving the pulse signal the number of times of determination from the speed sensor 31, that the vehicle V has started from a state in which the wheel is stationary while being in contact with step S, and has run on the step S.

Thus, erroneous determination attributable to a spin of the wheel or the like can be prevented, even when the wheel revolves despite the fact that the wheel does not run on the step S, such as when the wheel slips for a few revolutions. Further, even when a noise, which may be erroneously recognized as a pulse signal, is received not more than the number of times of determination despite the fact that the wheel does not revolve, erroneous determination by the noise can be prevented.
(5) In the above-described embodiment, the speed sensor 31 that detects the roughness of the road surface on which the step S exists is included. The step determination unit 44 changes the value of the contact determination threshold to be larger, as the roughness of the road surface detected by the speed sensor 31 is rougher. Specifically, the step determination unit 44 sets the contact determination threshold to the bad road threshold which is larger than the good road threshold, when the roughness of the road surface is rougher than flatness and has an uneven shape.

The driving force necessary for starting the vehicle V increases when the road surface is rough, compared to when the road surface is flat. Therefore, the braking/driving impulse when starting the vehicle V from a state in which the wheel is stationary while being in contact with the step S varies between when the road surface is rough and when the road surface is flat. Then, the disturbance impulse when starting the vehicle V from a state in which the wheel is stationary while being in contact with the step S varies between when the road surface is rough and when the road surface is flat.

Therefore, the variation of the disturbance impulse which gradually changes by gradually increasing the driving force in order to start the vehicle V from a state of being stationary while being in contact with the step S changes depending on the roughness of the road surface. Therefore, when the contact determination threshold is a constant value, contact determination with the step S may be erroneously determined due to the roughness of the road surface. For example, when the disturbance impulse increases compared to when the road surface is flat because the road surface has an uneven shape, it may be erroneously determined that the vehicle V is in contact with the step S despite the fact that it is in a state of having not been in contact with the step S before starting.

On the other hand, by changing the contact determination threshold depending on the roughness of the road surface, the contact determination threshold can correspond to the variation of the disturbance impulse which changes depending on the roughness of the road surface.
(6) In the above-described embodiment, the braking/driving calculation unit 422 calculates the driving force and the braking force for running the vehicle V on the running road on which the step S exists. The impulse calculation unit 43 calculates the velocity impulse and the braking/driving impulse when the wheel of the running vehicle V has collided with the step S based on the driving force and the braking force calculated by the braking/driving calculation unit 422. The step determination unit 44 determines that the wheel of the vehicle V has collided with the step S, when the difference between the velocity impulse and the braking/driving impulse is equal to or greater than the collision determination threshold.

Thus, by determining that the wheel of the running vehicle V has collided with the step S based on the difference between the velocity impulse and the braking/driving impulse, the vehicle control device 1 can accurately detect that the wheel of the running vehicle V has collided with the step S.
(7) In the above-described embodiment, the braking/driving calculation unit 422 calculates the velocity impulse and the braking/driving impulse after the step determination unit 44 determined that the vehicle V has collided with the step S. The step determination unit 44 determines that the vehicle V has run on the step S, when the braking/driving impulse after it was determined that the vehicle V has collided with the step S is equal to or greater than the difference between the velocity impulse and the braking/driving impulse after it was determined that the vehicle V has collided with the step S.

For preventing the vehicle speed from abruptly rising, it is required to lower the driving force immediately after the wheel of the running vehicle V has run on the step S compared to the set value set for passing over the step S. Alternatively, it is required to raise the braking force immediately after the wheel has run on the step S compared to the set value set for passing over the step S.

On the other hand, by determining that the wheel of the running vehicle V has run on the step S based on the braking/driving impulse and the velocity impulse after it was determined that the vehicle V has collided with the step S, it can be accurately detected that the wheel of the running vehicle V has run on the step S. Therefore, the vehicle control device 1 can adjust the driving force and the braking force immediately after the wheel has run on the step S.
(8) In the above-described embodiment, the speed sensor 31 that detects the roughness of the road surface on which the step S exists is included. The step determination unit 44 changes the value of the contact determination threshold to be larger, as the roughness of the road surface detected by the speed sensor 31 is rougher. Specifically, the step determination unit 44 sets the collision determination threshold to the bad road threshold which is larger than the good road threshold, when the roughness of the road surface is rougher than flatness and has an uneven shape.

The driving force necessary for running the vehicle V at a constant speed increases when the road surface is rough, compared to when the road surface is flat. Therefore, the braking/driving impulse when running the vehicle V varies between when the road surface is rough and when the road surface is flat. Then, the disturbance impulse when the wheel of the running wheel V has collided with the step S varies between when the road surface is rough and when the road surface is flat.

Therefore, the variation of the disturbance impulse which gradually changes by gradually increasing the driving force after the wheel of the running vehicle V has collided with the step S changes depending on the roughness of the road surface. Therefore, when the collision determination threshold is a constant value, collision determination with the step S may be erroneously determined due to the roughness of the road surface.

On the other hand, by changing the collision determination threshold depending on the roughness of the road surface, the collision determination threshold can correspond to the variation of the disturbance impulse which changes depending on the roughness of the road surface.
(9) In the above-described embodiment, the braking/driving calculation unit 422 calculates the driving force and the braking force for running the vehicle V on the running road on which the step S exists. The impulse calculation unit 43 calculates the velocity impulse and the braking/driving impulse when the wheel of the running vehicle V descends from the step S based on the driving force and the braking force calculated by the braking/driving calculation unit 422. The step determination unit 44 determines that the wheel of the vehicle V has descended from the step S, when the difference between the velocity impulse and the braking/driving impulse is equal to or greater than the descending determination threshold.

For preventing the vehicle speed from abruptly rising, it is required to lower the driving force immediately after the wheel of the running vehicle V has descended from the step S compared to the set value set before descending from the step S. Further, it is required to raise the braking force immediately after the wheel has descended from the step S compared to the set value set before descending from the step S.

On the other hand, by determining that the wheel of the running vehicle V has descended from the step S based on the braking/driving impulse and the velocity impulse when the vehicle V descends from the step S, it can be accurately detected that the wheel of the vehicle V has descended from the step S. Therefore, the vehicle control device 1 can adjust the driving force and the braking force immediately after the wheel has descended from the step S.
(10) In the above-described embodiment, the speed sensor 31 that detects the roughness of the road surface on which the step S exists is included. The step determination unit 44 changes the value of the descending determination threshold to be larger, as the roughness of the road surface detected by the speed sensor 31 is rougher. Specifically, the step determination unit 44 sets the descending determination threshold to the bad road threshold which is larger than the good road threshold, when the roughness of the road surface is rougher than flatness and has an uneven shape.

The driving force necessary for running the vehicle V increases when the road surface is rough, compared to when the road surface is flat. Therefore, the braking/driving impulse when running the vehicle V varies between when the road surface is rough and when the road surface is flat. Then, the disturbance impulse when the wheel of the running wheel V has collided with the step S varies between when the road surface is rough and when the road surface is flat.

Therefore, the variation of the disturbance impulse which gradually changes by gradually decreasing the driving force after the wheel of the running vehicle V has descended from the step S changes depending on the roughness of the road surface. Therefore, when the descending determination threshold is a constant value, determination that the wheel has descended from the step S may be erroneously determined due to the roughness of the road surface.

On the other hand, by changing the descending determination threshold depending on the roughness of the road surface, the descending determination threshold can correspond to the variation of the disturbance impulse which changes depending on the roughness of the road surface.
(11) In the above-described embodiment, the step determination unit 44 determines the roughness of the road surface based on the vehicle speed detected by the sensor unit 30.

Thus, the configuration of the vehicle control device 1 can be simplified, compared to a configuration in which a sensor dedicated to detecting the roughness of the road surface is provided.

### OTHER EMBODIMENTS

Although a representative embodiment of the present disclosure has been described, the present disclosure is not limited to the above-described embodiment, which can be variously modified, for example, as below.

In the above-described embodiment, an example in which the vehicle control device 1 is configured integrally with the automatic parking system and can execute the automatic parking process executed by the automatic parking system has been described. However, the present disclosure is not limited thereto.

For example, the vehicle control device 1 may be configured separately from the automatic parking system and uncapable of executing the automatic parking process. Then, the vehicle control device 1 may execute the above-described control process, not in the automatic parking process, but when the vehicle V is started by an operation of the driver and when the vehicle V is run by an operation of the driver.

In the above-described embodiment, an example in which the change source is the step S has been described. However, the present disclosure is not limited thereto. The change source is one that has a predetermined height and prevents running of the vehicle V, and includes one other than the step S (for example, stone or the like) as long as it is one that changes the vehicle speed by the vehicle V passing over or descending from the change source.

In the above-described embodiment, an example in which the contact determination threshold, the collision determination threshold, and the descending determination threshold are each set to one of the good road threshold and the bad road threshold depending on the roughness of the road surface has been described. However, the present disclosure is not limited thereto.

For example, the contact determination threshold, the collision determination threshold, and the descending determination threshold may be each set to three or more levels of thresholds depending on the roughness of the road surface.

In the above-described embodiment, an example in which the vehicle control device 1 is applied to the electric vehicle, and the torque sensor 34 detects as the driving force the output torque of the motor for running has been described. However, the present disclosure is not limited thereto.

For example, the vehicle control device 1 may be applied to a car having an engine as a driving source. In this case, the torque sensor 34 may be configured to directly detect as the driving force the driving force output by the engine or may be configured by an accelerator sensor that detects the driving force of the engine by detecting the operation amount of the accelerator pedal.

In the above-described embodiment, it is needless to say that elements constituting the embodiment are not necessarily essential except for when particularly specified as being essential or when considered as being apparently essential in principle.

When numerical values such as the quantities, numerical values, amounts, and ranges of the constituents of the embodiment are described in the above-described embodiment, the present disclosure is not limited to the specific numbers except for when particularly specified as being essential or when apparently limited to the specific numbers in principle.

When the shapes, positional relationships, and the like of the constituents are described in the above-described embodiment, the present disclosure is not limited to the shapes, positional relationships, and the like except for when particularly specified or when limited to the specific shapes, positional relationships, and the like in principle.

The automatic parking control device 40 and the method therefor of the present disclosure may be realized by a dedicated computer provided by constituting a processor and a memory programmed to execute one or a plurality of functions embodied by a computer program. The automatic parking control device 40 and the method therefor of the present disclosure may be realized by a dedicated computer provided by constituting a processor with one or more dedicated hardware logic circuits. The automatic parking control device 40 and the method therefor of the present disclosure may be realized by one or more dedicated computers constituted by a combination of a processor and a memory programmed to execute one or a plurality of functions and a processer constituted by one or more hardware logic circuits. The computer program may be stored, as an instruction to be executed by the computer, in a computer-readable non-transitory tangible memory medium.

### ASPECTS OF PRESENT DISCLOSURE

The above-described present disclosure can be understood as, for example, the below-described aspects.

### First Aspect

A vehicle control device that controls a driving force and a braking force of a vehicle passing over a change source(S) which changes a vehicle speed by a wheel of the vehicle passing over or descending, including:
an impulse calculation unit (43) that calculates an impulse acting on the vehicle when the vehicle passes over the change source and outputs impulse information corresponding to the calculated impulse;
a passage determination unit (44) that determines passage over the change source, based on the impulse information output by the impulse calculation unit; and
a braking/driving calculation unit (422) that calculates the driving force and the braking force when passing over the change source, based on a determination result of the passage determination unit, in which
the impulse calculation unit calculates, as the impulse information, a velocity impulse based on the vehicle speed when passing over the change source and a braking/driving impulse based on the driving force and the braking force when passing over the change source, and
the passage determination unit determines passage over the change source based on a difference between the velocity impulse and the braking/driving impulse calculated by the impulse calculation unit.

### Second Aspect

The vehicle control device according to the first aspect, in which
the braking/driving calculation unit calculates the driving force and the braking force for the wheel starting from a state of being stationary while being in contact with the change source and the wheel running on the change source,
the impulse calculation unit calculates the velocity impulse and the braking/driving impulse when the vehicle starts from a state in which the wheel is stationary while being in contact with the change source based on the driving force and the braking force calculated by the braking/driving calculation unit, and
the passage determination unit determines that the vehicle is in contact with the change source, when a difference between the velocity impulse and the braking/driving impulse is equal to or greater than a contact determination threshold that is a threshold for determining whether the wheel is in a state of being in contact with the change source.

### Third Aspect

The vehicle control device according to the second aspect, including a speed detection unit (31) that detects the vehicle speed and outputs information corresponding to the vehicle speed detected,
in which the passage determination unit determines, based on information corresponding to the vehicle speed output by the speed detection unit, that the wheel has run on the change source from a state of being stationary while being in contact with the change source.

### Fourth Aspect

The vehicle control device according to the third aspect, in which
the speed detection unit is provided to each of a plurality of the wheels of the vehicle, and
the passage determination unit determines, based on information corresponding to the vehicle speed output by a plurality of the speed detection units, that the wheel has started and run on the change source from a state of being stationary while being in contact with the change source.

### Fifth Aspect

The vehicle control device according to the third or fourth aspect, in which
the speed detection unit is provided to the wheel of the vehicle, and outputs pulse signals of a quantity corresponding to a revolution angle of the wheel, and
the passage determination unit determines, in response to receiving a plurality of the pulse signals from the speed detection unit, that the wheel has started and run on the change source from a state of being stationary while being in contact with the change source.

### Sixth Aspect

The vehicle control device according to any one of the second to fifth aspects, including a road surface detection unit (20, 31, 32) that detects a roughness of a road surface on which the change source exists,
in which the passage determination unit changes a value of the contact determination threshold to be larger, as the roughness of the road surface detected by the road surface detection unit is rougher.

### Seventh Aspect

The vehicle control device according to any one of the first to sixth aspects, in which
the braking/driving calculation unit calculates the driving force and the braking force for running the vehicle on a running road on which the change source exists,
the impulse calculation unit calculates, based on the driving force and the braking force calculated by the braking/driving calculation unit, the velocity impulse and the braking/driving impulse when the wheel of the vehicle running has collided with the change source, and
the passage determination unit determines that the wheel of the vehicle has collided with the change source, when a difference between the velocity impulse and the braking/driving impulse is equal to or greater than a collision determination threshold that is a threshold for determining whether the wheel has collided with the change source.

### Eighth Aspect

The vehicle control device according to the seventh aspect, in which
the braking/driving calculation unit calculates the velocity impulse and the braking/driving impulse after the passage determination unit determined that the vehicle has collided with the change source, and
the passage determination unit determines that the vehicle has run on the change source, when the braking/driving impulse after it was determined that the vehicle has collided with the change source is equal to or greater than a difference between the velocity impulse and the braking/driving impulse after it was determined that the vehicle has collided with the change source.

### Ninth Aspect

The vehicle control device according to the seventh or eighth aspect, including a road surface detection unit (20, 31, 32) that detects a roughness of a road surface on which the change source exists,
in which the passage determination unit changes a value of the collision determination threshold to be larger, as the roughness of the road surface detected by the road surface detection unit is rougher.

### Tenth Aspect

The vehicle control device according to any one of the first to ninth aspects, in which
the braking/driving calculation unit calculates the driving force and the braking force for running the vehicle on a running road on which the change source exists,
the impulse calculation unit calculates, based on the driving force and the braking force calculated by the braking/driving calculation unit, the velocity impulse and the braking/driving impulse when the wheel of the vehicle running has descended from the change source, and
the passage determination unit determines that the wheel of the vehicle has descended from the change source, when a difference between the velocity impulse and the braking/driving impulse is equal to or greater than a descending determination threshold that is a threshold for determining whether the wheel has descended from the change source.

### Eleventh Aspect

The vehicle control device according to the tenth aspect, including a road surface detection unit (20, 31, 32) that detects a roughness of a road surface on which the change source exists,
in which the passage determination unit changes a value of the descending determination threshold to be larger, as the roughness of the road surface detected by the road surface detection unit is rougher.

### Twelfth Aspect

The vehicle control device according to any one of the sixth, ninth, and eleventh aspects, including a sensor unit (30) that detects at least one of the vehicle speed and an acceleration of the vehicle,
in which the passage determination unit determines the roughness of the road surface based on at least one of the vehicle speed and the acceleration detected by the sensor unit.

What is claimed is:

1. A vehicle control device configured to control a driving force and a braking force of a vehicle passing over a change source which changes a vehicle speed by a wheel of the vehicle passing over or descending, comprising:
an impulse calculation unit configured to calculate an impulse acting on the vehicle when the vehicle passes over the change source and outputs impulse information corresponding to the calculated impulse;
a passage determination unit configured to determine passage over the change source, based on the impulse information output by the impulse calculation unit; and
a braking/driving calculation unit configured to calculate the driving force and the braking force when passing over the change source, based on a determination result of the passage determination unit, wherein
the impulse calculation unit is configured to calculate, as the impulse information, a velocity impulse based on the vehicle speed when passing over the change source and a braking/driving impulse based on the driving force and the braking force when passing over the change source, and
the passage determination unit is configured to determine passage over the change source based on a difference between the velocity impulse and the braking/driving impulse calculated by the impulse calculation unit.

2. The vehicle control device according to claim 1, wherein
the braking/driving calculation unit is configured to calculate the driving force and the braking force for the wheel starting from a state of stationary while being in contact with the change source and the wheel running on the change source,
the impulse calculation unit is configured to calculate the velocity impulse and the braking/driving impulse when the vehicle starts based on a state in which the wheel is stationary while being in contact with the change source based on the driving force and the braking force calculated by the braking/driving calculation unit, and
the passage determination unit is configured to determine that the vehicle is in contact with the change source, when a difference between the velocity impulse and the braking/driving impulse is equal to or greater than a contact determination threshold that is a threshold for determining whether the wheel is in a state of being in contact with the change source.

3. The vehicle control device according to claim 2, further comprising
a speed detection unit configured to detect the vehicle speed and outputs information corresponding to the vehicle speed detected,
wherein the passage determination unit is configured to determine, based on information corresponding to the vehicle speed output by the speed detection unit, that the wheel has run on the change source from a state of being stationary while being in contact with the change source.

4. The vehicle control device according to claim 3, wherein
the speed detection unit is provided to each of a plurality of the wheels of the vehicle, and
the passage determination unit is configured to determine, based on information corresponding to the vehicle speed output by a plurality of the speed detection units, that the wheel has started and run on the change source from a state of being stationary while being in contact with the change source.

5. The vehicle control device according to claim 3, wherein
the speed detection unit is provided to the wheel of the vehicle, and outputs pulse signals of a quantity corresponding to a revolution angle of the wheel, and
the passage determination unit is configured to determine, in response to receiving a plurality of the pulse signals from the speed detection unit, that the wheel has started and run on the change source from a state of being stationary while being in contact with the change source.

6. The vehicle control device according to claim 2, further comprising
a road surface detection unit configured to detect a roughness of a road surface on which the change source exists,
wherein the passage determination unit is configured to change a value of the contact determination threshold to be larger, as the roughness of the road surface detected by the road surface detection unit is rougher.

7. The vehicle control device according to claim 1, wherein
the braking/driving calculation unit is configured to calculate the driving force and the braking force for running the vehicle on a running road on which the change source exists,
the impulse calculation unit is configured to calculate, based on the driving force and the braking force calculated by the braking/driving calculation unit, the velocity impulse and the braking/driving impulse when the wheel of the vehicle running has collided with the change source, and
the passage determination unit is configured to determines that the wheel of the vehicle has collided with the change source, when a difference between the velocity impulse and the braking/driving impulse is equal to or greater than a collision determination threshold that is a threshold for determining whether the wheel has collided with the change source.

8. The vehicle control device according to claim 7, wherein
the braking/driving calculation unit is configured to calculate the velocity impulse and the braking/driving impulse after the passage determination unit determined that the vehicle has collided with the change source, and
the passage determination unit is configured to determine that the vehicle has run on the change source, when the braking/driving impulse after it was determined that the vehicle has collided with the change source is equal to or greater than a difference between the velocity impulse and the braking/driving impulse after it was determined that the vehicle has collided with the change source.

9. The vehicle control device according to claim 7, further comprising
a road surface detection unit that detects a roughness of a road surface on which the change source exists,
wherein the passage determination unit is configured to change a value of the collision determination threshold to be larger, as the roughness of the road surface detected by the road surface detection unit is rougher.

10. The vehicle control device according to claim 1, wherein
the braking/driving calculation unit is configured to calculate the driving force and the braking force for running the vehicle on a running road on which the change source exists,
the impulse calculation unit is configured to calculate, based on the driving force and the braking force calculated by the braking/driving calculation unit, the velocity impulse and the braking/driving impulse when the wheel of the vehicle running has descended from the change source, and
the passage determination unit is configured to determine that the wheel of the vehicle has descended from the change source, when a difference between the velocity impulse and the braking/driving impulse is equal to or greater than a descending determination threshold that is a threshold for determining whether the wheel has descended from the change source.

11. The vehicle control device according to claim 10, further comprising
a road surface detection unit configured to detect a roughness of a road surface on which the change source exists,
wherein the passage determination unit is configured to change a value of the descending determination threshold to be larger, as the roughness of the road surface detected by the road surface detection unit is rougher.

12. The vehicle control device according to claim 6, further comprising
a sensor unit configured to detect at least one of the vehicle speed and an acceleration of the vehicle,
wherein the passage determination unit is configured to determine the roughness of the road surface based on at least one of the vehicle speed and the acceleration detected by the sensor unit.
